(19) United States
(12) Patent Application Publication
(10) Pub. No.: US 2025/0037918 A1
(43) Pub. Date: Jan. 30, 2025

(54) INDUCTANCE ASSEMBLY AND INTEGRATED POWER CONVERTER MODULE

(71) Applicant: SHANGHAI METAPWR ELECTRONICS CO., LTD, Shanghai (CN)

(72) Inventors: Mingzhun ZHANG, Shanghai (CN); Qingdong CHEN, Shanghai (CN); Xiaoni Xin, Shanghai (CN); Shouyu Hong, Shanghai (CN)

(73) Assignee: SHANGHAI METAPWR ELECTRONICS CO., LTD, Shanghai (CN)

(21) Appl. No.: 18/780,540

(22) Filed: Jul. 23, 2024

(30) Foreign Application Priority Data
Jul. 24, 2023 (CN) 202310907042.2
Mar. 29, 2024 (CN) 202410376270.6

(51) Int. Cl. H01F 17/00; H01F 17/04; H01F 27/28

(52) U.S. Cl. CPC H01F 17/0006; H01F 17/041; H01F 27/2852; H01F 2017/008

(57) ABSTRACT

The application discloses an inductance assembly and an integrated power converter module. An inductance assembly is arranged on a bottom substrate, after integral plastic packaging, a signal electrical connecting piece is formed on the plastic packaging material through electroplating, and the signal electrical connector extends from the top surface of the inductance assembly to the side surface of the plastic packaging material and then extends to the bottom surface of the bottom substrate. The auxiliary winding is added to the second aspect to be coupled with the main winding to form a TLVR inductor for improving the dynamic performance of the VRM module. The VIN electrical connector is arranged between the main winding and the signal electrical connector, the middle portion of the VIN electrical connector is widened, and the transmission signal on the hopping signal interference signal electrical connector of the main winding is effectively avoided.

### CROSS-REFERENCE TO RELATED APPLICATION

This application claims the priority benefit of Chinese patent application 202310907042.2 filed on Jul. 24, 2023, and Chinese patent application 202410376270.6 filed on Mar. 29, 2024. The entirety of each of the above-mentioned patent applications is hereby incorporated by reference herein and made a part of this specification.

### BACKGROUND

### Description of Related Art

In recent years, with the development of technologies such as data centers, artificial intelligence, supercomputers and the like, more and more powerful ASICs are applied, such as CPUs, GPUs, machine learning accelerators, network switches, servers and the like, which consume a large amount of current, for example, the required current can reach thousands of amperes; and the current has the characteristic of rapid jump. A voltage regulator module (VRM, Voltage Regulator Modules, ie, a power converter module according to the present application), comprising a buck circuit (Buck), is conventionally used to supply such a load. And these loads have lower and lower voltages, now as low as 0.65V, and the current of the load continues to increase. In the VRM module of the low-voltage large current, how to improve the efficiency, how to improve the transient response capability and improve the power density to form a key for meeting the power supply requirement of the ASIC is also a core problem designed by the VRM module.

Along with the continuous increase of the load current, the heat dissipation problem of the VRM module is a key problem needing to be considered. At present, in order to share a radiator with a load ASIC, the VRM module reduces the upward thermal resistance of the top surface of the VRM module, the switch device serving as a heat source is arranged close to the top surface of the VRM module, and the filter inductor is arranged close to the bottom surface of the VRM module; the input power current and the control signal need to be transmitted from the main board adjacent to the bottom surface of the VRM module to the switch device on the top surface, and signals such as current sampling and temperature sampling related to the working state of the top surface switch device need to be transmitted from the top surface to the main board adjacent to the bottom surface; therefore, the output filter inductor in the VRM module needs to integrate the power connector and the signal connector;

In a traditional power supply mode, the VRM module and the load level are adjacently arranged on the same surface of the mainboard, namely a horizontal power supply mode. In the power supply mode, the distance between the VRM module and the load is far, and the impedance of the power distribution network (PDN) is large; and when the load current becomes larger and larger, for example, when the load current is up to thousands of amperes, the loss on the PDN seriously affects the efficiency of transmitting energy to the load by the VRM module. In order to further improve the efficiency, the impedance of the PDN needs to be reduced, and therefore, the vertical power supply mode is adopted. The vertical power supply mode is that the VRM module and the load are vertically stacked on the front face and the back face of the mainboard, so that the energy transmission path of the PDN is greatly reduced, and the energy transmission efficiency is greatly improved; but the problem that the output capacitor is originally placed is occupied by the VRM module along with the vertical power supply mode, so that the output capacitor is not placed in space, and the dynamic performance of the VRM module is seriously influenced.

Therefore, how to integrate the output capacitor in the VRM module so as to improve the dynamic performance of the module. At the same time, how to reduce the number of exposed solder joints so as to improve the reliability of the VRM module under the condition of reflow soldering is an urgent problem to be solved.

### SUMMARY

The application provides an inductance assembly comprises a magnetic core, a first main winding, a second main winding, a first auxiliary winding and a second auxiliary winding;
the magnetic core comprises a top surface and a bottom surface opposite to each other, a first side surface and a third side surface opposite to each other, and a second side surface and a fourth side surface opposite to each other;
the first pin of the first main winding and the first pin of the second main winding are arranged on the top surface of the magnetic core; a second pin of the first main winding and a second pin of the second main winding, and at least one pin of the first auxiliary winding and at least one pin of the second auxiliary winding are arranged on the bottom surface of the magnetic core; the first main winding and the second main winding respectively pass through the magnetic core; the first auxiliary winding is coupled with the first main winding, and the second auxiliary winding is coupled with the second main winding; and any auxiliary winding is electrically isolated from the adjacent main winding.

Preferably, wherein the first main winding, the first auxiliary winding, the second auxiliary winding and the second main winding are sequentially arranged; the first auxiliary winding is arranged adjacent to the first main winding, and the second auxiliary winding is arranged adjacent to the second main winding; the first main winding and the second main winding respectively comprise a main body, a first end part and a second end part, and the first auxiliary winding and the second auxiliary winding comprise a main body, a first end part and a second end part respectively; the main body of the first auxiliary winding and the main body of the first main winding extend from the respective first end to the second end in the same direction, and the main body of the second auxiliary winding and the main body of the second main winding extend from the respective first end to the second end in the same direction.

Preferably, the upper end of the first auxiliary winding and the upper end of the second auxiliary winding are exposed out of the top surface of the magnetic core, and the lower end of the first auxiliary winding and the lower end of the second auxiliary winding are exposed out of the bottom surface of the magnetic core; the first main winding, the second main winding, the first auxiliary winding and the second auxiliary winding are all arranged close to the first side surface, and the second ends of the first main winding, the second main winding, the first auxiliary winding and the second auxiliary winding are all arranged close to the third side surface.

Preferably, the upper end and the lower end of the first auxiliary winding and the upper end and the lower end of the second auxiliary winding are exposed out of the bottom surface of the magnetic core; the first main winding, the second main winding, the first auxiliary winding and the second auxiliary winding are all arranged close to the first side surface, and the second ends of the first main winding, the second main winding, the first auxiliary winding and the second auxiliary winding are all arranged close to the third side surface.

Preferably, wherein the first auxiliary winding, the first main winding, the second main winding and the second auxiliary winding are sequentially arranged; the first auxiliary winding is arranged adjacent to the first main winding, and the second auxiliary winding is arranged adjacent to the second main winding; the first main winding and the second main winding both comprise a main body, a first end part and a second end part, and the first auxiliary winding and the second auxiliary winding both comprise a main body, a first end part and a second end part; the main body of the first auxiliary winding and the main body of the first main winding extend from the respective first end to the second end in the same direction, and the main body of the second auxiliary winding and the main body of the second main winding extend from the respective first end to the second end in the same direction; the first end of the first auxiliary winding, the first end of the first main winding, the second end of the second main winding and the second end of the second auxiliary winding are arranged adjacent to the first side surface, and the second end of the first auxiliary winding, the second end of the first main winding, the first end of the second main winding and the first end of the second auxiliary winding are all arranged close to the third side surface.

Preferably, wherein the first main winding and the second main winding both comprise a main body, a first end part and a second end part, and the first auxiliary winding and the second auxiliary winding both comprise a main body, a first end partand a second end part; the main bodies of the first main winding and the second main winding are C-shaped, and the main bodies of the first auxiliary winding and the second auxiliary winding extend from the respective first end parts to the second end parts in the same direction; a first end part and a second end part of the first main winding, the first end part of the first auxiliary winding and the first end part of the second auxiliary winding are arranged adjacent to the first side surface, the first end part and the second end part of the second main winding are arranged close to the third side surface, and the second end part of the first auxiliary winding and the second end part of the second auxiliary winding are arranged close to the third side surface; the first auxiliary winding is arranged adjacent to the second side surface and is adjacent to the main body of the first main winding and the main body of the part of the second main winding, and the second auxiliary winding is arranged adjacent to the fourth side surface and is adjacent to the main body of the other part of the first main winding and the main body of the other part of the second main winding; the first auxiliary winding is coupled to the first main winding, the first auxiliary winding is coupled to the second main winding, the second auxiliary winding is coupled to the first main winding, and the second auxiliary winding is coupled to the second main winding.

Preferably, wherein the inductance assembly is formed by pressing and forming a magnetic core material, a first main winding, a second main winding, a first auxiliary winding and a second auxiliary winding.

Preferably, wherein the magnetic core is formed by assembling.

Preferably, wherein the inductance assembly further comprises at least one VIN electrical connector and two GND electrical connectors; and the at least one VIN electrical connector is arranged adjacent to the first side surface and/or the third side surface, and the two GND electrical connectors are arranged on the second side surface and the fourth side surface respectively; the upper ends of the VIN electrical connector and the GND electrical connector are exposed out of the top surface of the magnetic core, and the lower ends of the VIN electrical connector and the GND electrical connector are exposed out of the bottom surface of the magnetic core.

Preferably, wherein at least one of the VIN electrical connections is disposed adjacent to the first side surface and is disposed between the first main winding and the second main winding.

Preferably, wherein the at least one VIN electrical connector is disposed adjacent to the third side surface, the VIN electrical connector includes a first pin, a second pin, and a middle portion, the first pin is disposed on a top surface of the magnetic core, the second pin is disposed on a bottom surface of the magnetic core, and a width of the middle portion is greater than a width of the first pin and the second pin.

Preferably, wherein the inductance assembly further comprises a signal electrical connector, and at least one part of the signal electrical connector is arranged on the outer side of the middle portion of the VIN electrical connector; and the middle portion is used for shielding electromagnetic interference of the first main winding and the second main winding on at least one part of the signal electrical connector.

Preferably, wherein the inductance assembly further comprises a signal electrical connector, and at least a part of the signal electrical connector is disposed adjacent to the third side surface.

Preferably, wherein the signal electrical connector is a pin header.

Preferably, wherein the VIN electrical connector, the GND electrical connector, or the signal electrical connector are formed by a metallization process.

Preferably, wherein the VIN electrical connector or the GND electrical connector is a metal column.

Preferably, wherein a second pin of the first main winding and a second pin of the second main winding protrude out of the bottom surface of the magnetic core;

the first pin and the second pin of the VIN electrical connector are respectively connected to the middle portion by means of a step structure, and the step structure is used for avoiding the signal electrical connector.

Preferably, wherein the magnetic core is provided with an air gap; and at least a part of the air gap is located between the first main winding and the second main winding.

Preferably, wherein the magnetic core is formed by assembling, and the air gap divides the magnetic core into two halves in the vertical direction; the magnetic core is further provided with a groove, and the groove is used for accommodating the first main winding and the second main winding, and the groove is communicated with the air gap.

Preferably, wherein the air gap comprises a first air gap, the first air gap is a horizontal flat through hole shape, the first air gap penetrates from one side surface of the magnetic core to the opposite other side surface, and the first air gap extends from the main winding main body of the first main winding to the main winding main body of the second main winding.

Preferably, wherein a second end of the first auxiliary winding and a second end of the second auxiliary winding are bent along a middle area of the bottom surface of the magnetic core, and a second pin is formed in a middle area of the bottom surface.

An inductance assembly comprises a magnetic core, a first main winding, a second main winding, a VIN electrical connector and a GND electrical connector;
the magnetic core comprises a top surface and a bottom surface opposite to each other, a first side surface and a third side surface opposite to each other, and a second side surface and a fourth side surface opposite to each other;
the first pin of the first main winding and the first pin of the second main winding are arranged on the top surface of the magnetic core; the second pin of the first main winding and the second pin of the second main winding are arranged on the bottom surface of the magnetic core; the first main winding and the second main winding respectively penetrate through the magnetic core;
the VIN electrical connector is arranged adjacent to the third side surface, and the two GND electrical connectors are arranged on the second side surface and the fourth side surface respectively; the upper ends of the VIN electrical connector and the GND electrical connector are exposed out of the top surface of the magnetic core, and the lower ends of the VIN electrical connector and the GND electrical connector are exposed out of the bottom surface of the magnetic core; the VIN electrical connector comprises a first pin, a second pin and a middle portion, the first pin is arranged on the top surface of the magnetic core, the second pin is arranged on the bottom surface of the magnetic core, and the width of the middle portion is larger than that of the first pin and the width of the second pin.

Preferably, the inductance assembly further comprises a plastic package body and a signal electrical connector, wherein the plastic package body covers the magnetic core, the VIN electrical connector and the GND electrical connector, and at least a part of the signal electrical connector is arranged on the outer side of the middle portion of the VIN electrical connector; and the middle portion is used for shielding electromagnetic interference of the first main winding and the second main winding on at least a part of the signal electrical connector.

Preferably, wherein the first main winding and the second main winding are I-shaped.

Preferably, wherein the first main winding and the second main winding respectively comprise a first end part a main body and a second end part, and main bodies of the first main winding and the second main winding extend from respective first end parts to second end parts in opposite directions; the first end of the first main winding and the second end of the second main winding are arranged adjacent to the first side surface, and the second end of the first main winding and the first end of the first main winding are arranged close to the third side surface.

Preferably, wherein the VIN electrical connector and the GND electrical connector are formed by a metallization process.

Preferably, wherein the VIN electrical connector and the GND electrical connector are metal columns.

Preferably, wherein the magnetic core is provided with an air gap; and at least a part of the air gap is located between the first main winding and the second main winding.

Preferably, wherein the air gap divides the magnetic core into two halves in the vertical direction, the magnetic core is further provided with a groove, the groove is used for accommodating the first main winding and the second main winding, and the groove is in communication with the air gap.

An integrated power converter module comprises the inductance assembly of claim 13 or 23; the integrated power converter module further comprises a top assembly and a bottom substrate, the top assembly is arranged on the top surface of the inductance assembly, and the bottom substrate is arranged on the bottom surface of the inductance assembly; the first pin of the first main winding, the first pin of the second main winding, the upper end of the VIN electrical connector and the upper end of the GND electrical connector are electrically connected with the top assembly, the second pin of the first main winding, the second pin of the second main winding, the lower end of the VIN electrical connector and the lower end of the GND electrical connector are electrically connected with the bottom substrate.

Preferably, wherein the signal electrical connector extends from the top surface of the inductance assembly to the bottom surface of the bottom substrate through the side surface of the plastic packaging material.

Preferably, the upper end of the signal electrical connector is arranged on the top surface of the inductance assembly and is electrically connected with the top assembly; and the lower end of the signal electrical connector is arranged on the bottom surface of the inductance assembly and is electrically connected with the bottom substrate.

Preferably, the integrated power converter module further comprising an output capacitor, wherein the output capacitor is arranged between the magnetic core and the bottom substrate; one end of the output capacitor, the second pin of the first main winding and the lower end of the second main winding are electrically connected.

Preferably, the first pin and the second pin of the VIN electrical connector are respectively connected to the middle portion of the VIN electrical connector by means of a step structure, and the step structure is used for avoiding the signal electrical connector.

Preferably, wherein the top assembly comprises a top substrate, an input capacitor and two IPM units; the IPM unit is electrically connected with a first pin of the VIN electrical connector, the IPM unit is electrically connected with the upper end of the GND electrical connector, the upper end of the first main winding is electrically connected with one of the two IPM units, and the upper end of the second main winding is electrically connected with the other one of the two IPM units.

An integrated power converter module comprises an inductance assembly, a bottom substrate, a plastic packaging material and a signal electrical connector;
the inductance assembly is arranged on the top surface of the bottom substrate; the plastic packaging material wraps part of the top surfaces of the inductance assembly and the bottom substrate;
the inductance assembly comprises a magnetic core, a first main winding, a second main winding, a VIN electrical connector and a GND electrical connector;
the upper end of the first main winding, the upper end of the second main winding, the upper end of the VIN electrical connector and the upper end of the GND electrical connector are exposed out of the plastic packaging material from the top surface of the inductance assembly respectively, and the lower end of the first main winding, the lower end of the second main winding, the lower end of the VIN electrical connector and the lower end of the GND electrical connector are electrically connected with the bottom substrate respectively; the first main winding and the second main winding respectively penetrate through the magnetic core; the signal electrical connector extends from the top of the inductance assembly to the bottom surface of the bottom substrate through the side surface of the plastic packaging material; and the signal electrical connector is formed through a metallization process.

Preferably, the side surface of the plastic packaging material is formed through plate splitting and cutting, and the signal electrical connector is an electroplated half-hole.

Preferably, the integrated power converter module further comprises a top assembly, and the top assembly is arranged adjacent to the top surface of the magnetic core; the top assembly comprises a top substrate, an input capacitor and two IPM units; the input capacitor and the two IPM units are arranged on the top surface of the top substrate; the IPM unit is electrically connected with the upper end of the VIN electrical connector; the IPM unit is electrically connected with the upper end of the GND electrical connector; the upper end of the first main winding is electrically connected with one of the two IPM units, and the upper end of the second main winding is electrically connected with the other one of the two IPM units.

Preferably, the integrated power converter module further comprising an output capacitor, wherein the output capacitor is arranged between the magnetic core and the bottom substrate; one end of the output capacitor and the lower end of the first main winding are electrically connected with the lower end of the second main winding.

Preferably. the integrated power converter module further comprises a metal frame, wherein the metal frame is used for electrically connecting the inductance assembly with the bottom substrate; the metal frame is arranged between the magnetic core and the bottom substrate; and the metal frame is arranged around the output capacitor, and the metal frame is provided with a gap or a groove allowing plastic packaging materials to flow in.

Preferably, wherein the magnetic core is provided with a first side surface and a third side surface which are opposite, and the magnetic core is further provided with a second side surface and a fourth side surface opposite to each other; and the VIN electrical connector is arranged on the first side surface and/or the third side surface, and the GND electrical connector is arranged on the second side surface and/or the fourth side surface.

Preferably, wherein the inductance assembly further comprises a first auxiliary winding and a second auxiliary winding; the first auxiliary winding is positively coupled with the first main winding, and the second auxiliary winding is positively coupled with the second main winding; and the first auxiliary winding and the second auxiliary winding are used for forming a closed loop of a TLVR inductance technology.

Preferably, wherein the first main winding and the second main winding respectively comprise a main body, a first end part of the main winding and a second end part of the main winding; the first end part of the main winding extends from one end of the main winding main body to the top surface of the magnetic core, and the second end part of the main winding extends from the other end of the main winding main body to the bottom substrate of the magnetic core; and the main winding main body is horizontally arranged.

Preferably, wherein the inductance assembly further comprises a first auxiliary winding and a second auxiliary winding; and the first auxiliary winding and the second auxiliary winding respectively comprise an auxiliary winding main body, a first end part of the auxiliary winding and a second end part of the auxiliary winding; the first end of the main winding extends from one end of the main winding main body to the bottom substrate, and the second end of the main winding extends from the other end of the main winding main body to the bottom substrate of the magnetic core; the auxiliary winding main body is positively coupled with the first main winding, and/or the auxiliary winding main body and the second main winding are positively coupled; and the first auxiliary winding and the second auxiliary winding are used for forming a closed loop of a TLVR inductance technology.

Preferably, a low magnetic permeability material is provided between the main body of the auxiliary winding and the main body of the main winding.

Preferably, wherein the main winding main body comprises a main winding first main body, a main winding second main body and a main winding third main body which are connected in sequence; the main winding first main body, the main winding second main body and the main winding third main body are arranged in a C-shaped horizontal bypass mode; the first main winding and the second main winding are arranged in a second-order rotation symmetry mode; the main winding second main body of the first main winding and the main winding second main body of the second main winding are reversely coupled; and the first main winding and the second main winding are both coupled with the first auxiliary winding, and the first main winding and the second main winding are both coupled with the second auxiliary winding.

Preferably, wherein the spacing between the signal electrical connector and the second end part of the nearest primary winding is less than the spacing between the signal electrical connector and the first end part of any primary winding.

Preferably, wherein the inductance assembly has a second-order rotationally symmetrical structure, and the signal electrical connector is arranged on the inductance assembly in a second-order rotationally symmetric manner.

An integrated power converter module comprises an inductance assembly, a bottom substrate, a plastic packaging material and a signal electrical connector, wherein the signal electrical connector is arranged on the side surface of the inductance assembly;
the inductance assembly comprises a magnetic core, a first main winding, a second main winding, a VIN electrical connector and a GND electrical connector;
the upper end of the first main winding, the upper end of the second main winding, the upper end of the VIN electrical connector and the upper end of the GND electrical connector are exposed out of the plastic packaging material from the top surface of the inductance assembly respectively, and the lower end of the first main winding, the lower end of the second main winding, the lower end of the VIN electrical connector and the lower end of the GND electrical connector are electrically connected with the bottom substrate respectively; and the first main winding and the second main winding respectively penetrate through the magnetic core;
the first main winding and the second main winding respectively comprise a main winding main body, a main winding first end and a main winding second end; the first end of the main winding extends from one end of the main winding main body to the top surface of the magnetic core, and the second end of the main winding extends from the other end of the main winding main body to the bottom substrate of the magnetic core; the main winding main body is horizontally arranged;
the first main winding and the second main winding are arranged in a second-order rotationally symmetrical manner, and the first main winding and the second main winding are reversely coupled.

Preferably, a low-permeability material is arranged between the main winding main body of the first main winding and the main winding main body of the second main winding.

Preferably, wherein the magnetic core is provided with an air gap; and at least a part of the air gap is located between the first main winding and the second main winding.

Preferably, wherein the air gap divides the magnetic core into two halves in the vertical direction.

Preferably, wherein the magnetic core is further provided with a groove, the groove is used for accommodating the first main winding and the second main winding, and the groove is communicated with the air gap.

Preferably, wherein the air gap comprises a first air gap, the first air gap is a horizontal flat through hole shape, the first air gap penetrates from one side surface of the magnetic core to the other opposite side surface, and the first air gap extends from the main winding main body of the first main winding to the main winding main body of the second main winding.

Preferably, wherein the air gap further comprises a second air gap, the second air gap is communicated with the first air gap, the second air gap is in a vertical groove shape, and the second air gap penetrates through the top surface of the magnetic core to the bottom surface of the magnetic core; and the second air gap extends from the first main winding or the second main winding to one side surface of the magnetic core.

Preferably, wherein the inductance assembly further includes a first auxiliary winding and a second auxiliary winding; and the first auxiliary winding and the second auxiliary winding respectively comprise an auxiliary winding main body, a first end part of the auxiliary winding and a second end part of the auxiliary winding; the first end of the main winding extends from one end of the main winding main body to the bottom substrate, and the second end of the main winding extends from the other end of the main winding main body to the bottom substrate of the magnetic core; the auxiliary winding is coupled with the first main winding, and/or the auxiliary winding is coupled with the second main winding; and the first auxiliary winding and the second auxiliary winding are used for forming a closed loop of a TLVR inductance technology.

Preferably, a low-permeability material is arranged between the auxiliary winding main body and the main winding main body.

Preferably, wherein the integrated power converter module further comprises a top assembly, and the top assembly is arranged close to the top surface of the magnetic core; the top assembly comprises a top substrate, an input capacitor and two IPM units; the input capacitor and the two IPM units are arranged on the top surface of the top substrate; the IPM unit is electrically connected with the first pin of the VIN electrical connector; the IPM unit is electrically connected with the upper end of the GND electrical connector; the upper end of the first main winding is electrically connected with one of the two IPM units, and the upper end of the second main winding is electrically connected with the other one of the two IPM units; and the two IPM units are arranged in a second-order rotating symmetry mode.

Preferably, wherein the magnetic core is provided with a first side surface and a third side surface opposite to each other, and the magnetic core further has a second side surface and a fourth side surface opposite to each other; the VIN electrical connector is arranged on the first side surface and/or the third side surface, and the GND electrical connector is arranged on the second side surface and/or the fourth side surface.

Compared with the prior art, the application has the following beneficial effects:

The inductance assembly is arranged on the bottom substrate, after integral plastic packaging, the plastic packaging material is electroplated to form the signal electric connecting piece, and the signal electric connecting piece extends from the top of the inductance assembly to the side face of the plastic packaging material and then extends to the bottom face of the bottom substrate; the auxiliary winding is added to be coupled with the main winding to form a TLVR inductor, and the TLVR inductor is used for improving the dynamic performance of the VRM module According to the application, the Vin electric connecting piece is arranged between the main winding and the signal electric connecting piece, the middle part of the Vin electric connecting piece is widened, and the transmission signal on the hopping signal interference signal electric connecting piece of the main winding is effectively avoided

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1A is a schematic diagram of a circuit principle of a two-phase VRM module;

FIG. 1B is a schematic diagram of a circuit principle of a TLVR inductance technology;

FIG. 2A is a schematic diagram of an overall structure of an integrated power converter module;

FIG. 2B is an exploded view of the integrated power converter module;

FIG. 2C to FIG. 2F are structural exploded views of various components;

FIG. 2G is a process flow for implementing a signal electrical connector;

FIG. 3A is a schematic diagram of an overall structure of an integrated power converter module;

FIG. 3B is an exploded view of the integrated power converter module;

FIG. 3C to FIG. 3H are structural exploded views of various components;

FIG. 4A to FIG. 4B are schematic structural diagrams and exploded views of an inductance assembly;

FIG. 5A is a schematic structural diagram of a two-phase VRM step-down circuit;

FIG. 5B to FIG. 5G are exploded views of an inductance assembly and an interior thereof;

FIG. 5H to FIG. 5I are schematic structural diagrams and exploded views of another integrated inductor;

FIG. 6A to FIG. 6C are schematic structural diagrams and exploded views of another inductance assembly;

FIG. 7A to FIG. 7C are schematic structural diagrams and exploded views of another VRM module;

FIG. 8A to FIG. 8C are schematic structural diagrams and exploded views of another VRM module;

FIG. 9A to FIG. 9D are schematic structural diagrams and exploded views of another integrated inductor; and

FIG. 10A to FIG. 10B are schematic structural diagrams of another integrated inductor.

### DESCRIPTION OF THE EMBODIMENTS

The present application discloses various embodiments or examples of implementing the thematic technological schemes mentioned. To simplify the disclosure, specific instances of each element and arrangement are described below. However, these are merely examples and do not limit the scope of protection of this application. For instance, a first feature recorded subsequently in the specification formed above or on top of a second feature may include an embodiment where the first and second features are formed through direct contact, or it may include an embodiment where additional features are formed between the first and second features, allowing the first and second features not to be directly connected. Additionally, these disclosures may repeat reference numerals and/or letters in different examples. This repetition is for brevity and clarity and does not imply a relationship between the discussed embodiments and/or structures. Furthermore, when a first element is described as being connected or combined with a second element, this includes embodiments where the first and second elements are directly connected or combined with each other, as well as embodiments where one or more intervening elements are introduced to indirectly connect or combine the first and second elements.

One of the cores of the application is to provide a VRM module structure. On one hand, the inductance assembly is arranged on the bottom substrate, after integral plastic packaging, the plastic packaging material is electroplated to form a signal electric connecting piece, and the signal electrical connector extends from the top of the inductance assembly to the side face of the plastic packaging material and then extends to the bottom face of the bottom substrate; and the other core of the present application is to add an auxiliary winding to be coupled to the main winding to form a TLVR inductor for improving the dynamic performance of the VRM module The other core of the present application is to provide a VIN electrical connector between the main winding and the signal electrical connector for the structure of the two-phase VRM module, widen the middle portion of the VIN electrical connector, and effectively prevent the hopping signal of the primary winding from interfering with a transmission signal on the signal electrical connector.

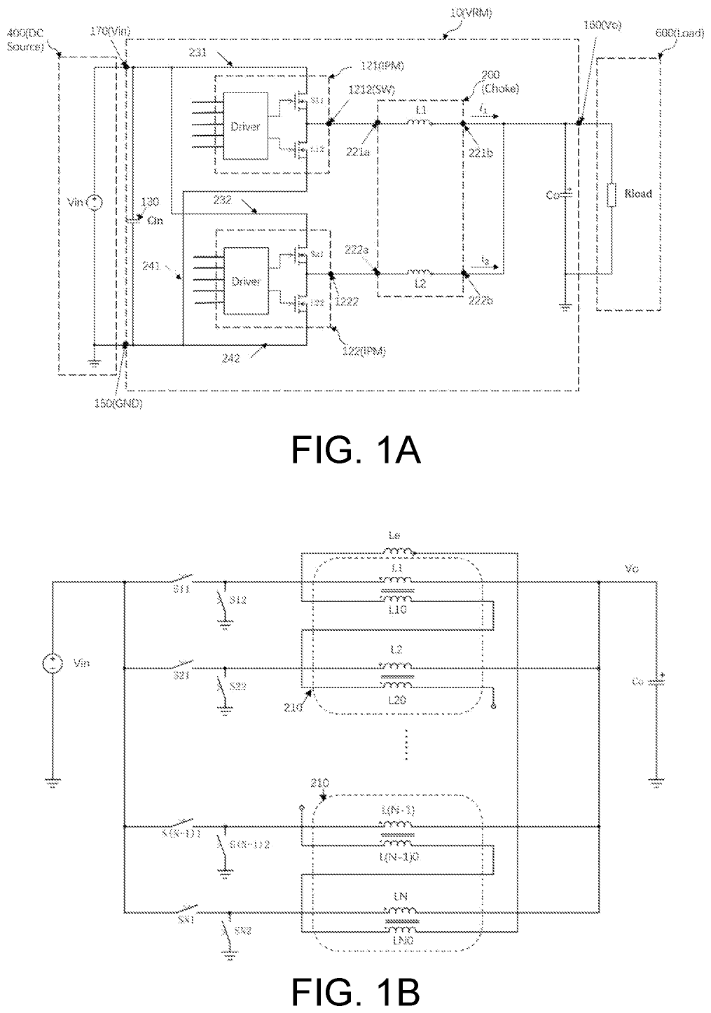

FIG. 1A shows a circuit structure of a two-phase VRM module in the prior art, and a person skilled in the art can also obtain the basic circuit structure of the VRM module with other phases by analogy. The two-phase VRM module 10 comprises an IPM (Intelligent Power Module) unit 121/122, a two-phase inductor 200 (Choke), a VIN electrical connector 231/232, a VIN end 170, a GND electrical connector 241/242, a GND end 150 and an input capacitor 130 (Cin). The two main windings L1/L2 of the two-phase inductor 200 may have magnetic coupling or may not have magnetic coupling; VIN electrical connectors 231/232 are connected in parallel and then connected to the input positive end of the VRM module 10, ie the VIN end 170; during application, the input positive end is externally connected with an input power supply 400, namely DC Source; the GND electrical connector 241/242 is connected to the input negative end of the VRM module 10 in parallel and then connected to the input negative end of the VRM module 10, namely the GND end 150. During application, the input negative end is externally connected with the input power supply 400, the input capacitor 130 is bridged between the input positive end and the input negative end, the input capacitor 130 provides a path for the high-frequency switch ripple current, and it is ensured that the input voltage is stable. The IPM unit 121 comprises two switching devices S11/S12 and a Driver, the switching device S11 is a high-end MOSFET, the switching device S12 is a low-end MOSFET, and the two MOSFETs are connected in series to form a bridge arm; one end of the bridge arm is connected with the VIN end 170; the other end of the bridge arm is connected with the GND end 150; and the structure of the IPM unit 122 is the same as that of the IPM unit 121. A voltage waveform phase difference of a bridge arm midpoint 1212/1222 (SW, also referred to as a switch point) of a bridge arm of the IPM unit 121/122 is 180 degrees, and a bridge arm midpoint 1212/1222 is respectively connected to an input end 221a/222a of the two-phase inductor 200; the output ends 221b/222b of the two-phase inductor 200 are connected in parallel to form the output positive end of the VRM module 10, that is, the VO end 160. The VO end 160 is electrically connected with the load and provides energy to the load together with the GND end 150. In another embodiment, the output end 221b/222b can also not be connected in parallel or in parallel in the two-phase VRM module 10. The output capacitor 360 (Co) is connected in parallel to the two ends of the load and is used for filtering the voltage at the two ends of the load and providing transient energy required by the load. Compared with the embodiment that the output capacitor 360 is arranged outside the two-phase VRM module 10, the integrated power converter module (when the phase number is 2 is a two-phase VRM module) integrates the IPM unit 121/122, the two-phase inductor 200, the VIN electric connector 231/232, the GND electric connector 241/242, the input capacitor 130 and the output capacitor 360 together to form an integrated assembly, so that a small-volume VRM module is realized, and the dynamic performance requirement of a load is met.

The power converter module disclosed by the application adopts a TLVR inductance technology, so that the dynamic performance of the power converter module can be further improved. After the plurality of two-phase VRM modules adopt the TLVR inductance technology, each phase of inductor can realize small equivalent dynamic inductance so as to improve the dynamic performance of the plurality of two-phase BUCK voltage reduction modules; and meanwhile, each phase of inductor maintains a large equivalent steady-state inductance so as to maintain the steady-state efficiency of the module. FIG. 1B is a circuit schematic diagram of a plurality of two-phase VRM modules adopting a TLVR inductance technology, and a plurality of two-phase VRM modules are connected in parallel to realize the function of the multiphase VRM module. The two-phase inductor in the first two-phase VRM module comprises a main winding L1 and a main winding L2, and the two-phase inductor in the same way to the N/2 two-phase VRM module comprises a main winding L (N−1) and a main winding LN; and when the auxiliary winding L10 . . . . LN0 is not arranged, the N-phase inductors formed by the main winding L1 . . . . LN are not coupled with each other. Auxiliary windings L10 and L20 are arranged in the first two-phase VRM module, and auxiliary windings L (N−1)0 and LN0 are arranged in the N/2 two-phase VRM modules; the auxiliary winding L10 . . . . LN0 and the corresponding main winding L1 . . . . LN are arranged in a positive coupling mode; and the terminal of the auxiliary winding L10 . . . . LN0 with the same dotted terminal as the main winding L1 . . . . LN input end is marked as a point end, and the terminal of the auxiliary winding L10 . . . . LN0 with the same dotted terminal as the main winding L1 . . . . LN output end is marked as a non-point end. All the auxiliary windings are connected in series end to end in series according to the mode that the non-point end of the previous auxiliary winding is connected in series with the point end of the next auxiliary winding, and a compensation inductor Le is externally connected; and the PWM signals of the N-phase Buck step-down circuit composed of the N/2 VRMs are arranged in a staggered phase (360/N) degree in sequence; and at the moment, the N-phase main windings L1 . . . . LN which are not coupled with each other originally are connected end to end through the auxiliary winding L10 . . . . LN0 and the compensation inductor Le, so that coupling is realized, and the advantage that the equivalent steady-state inductance reduction amplitude of each phase of inductance main winding is small, but the equivalent dynamic inductance is greatly reduced is obtained. In an extended embodiment, the compensation inductor Le can be replaced by a short wire because the auxiliary winding L10 . . . . LN0 is matched with the parasitic inductance of the loop formed by the short wiring, so that the equivalent steady-state inductance of each phase of inductance adopting the TLVR inductance technology can meet the requirement. Furthermore, the short wiring can be short-circuited with the GND end 150 to reduce the voltage value of the short wiring, thereby reducing the voltage value of each series connection point of the auxiliary winding L10 . . . . LN0. In another extended embodiment, the auxiliary winding L10 . . . . LN0 can be divided into two groups, the number of the auxiliary windings in each group is equal, and each group is matched with one compensation inductor Le or one short circuit line with the same inductance, so that two closed loops with basically the same loop inductance are formed; and in each closed loop, the voltage waveforms at the two ends of the auxiliary winding are sequentially staggered (180/N) degrees; and therefore, the voltage value of the auxiliary winding series connection point can be halved. In the extended embodiment, the number of auxiliary windings in the two closed loops can also be different, and correspondingly, the ratio of the loop inductance to the number of the auxiliary windings of the two closed loops is the same, and the similar advantages can also be obtained; a two-phase TLVR inductor 210 referred to as a two-phase TLVR inductor 210 can also replace the two-phase inductor 200 in FIG. 1A to realize a two-phase VRM module with a TLVR inductance technology, and the two-phase VRM module is referred to as a two-phase TLVR VRM module for short.

### Embodiment 1

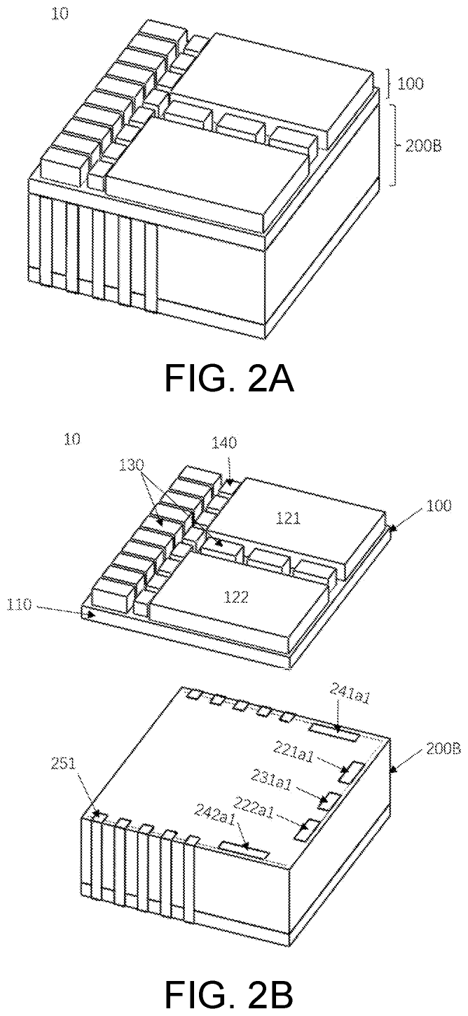

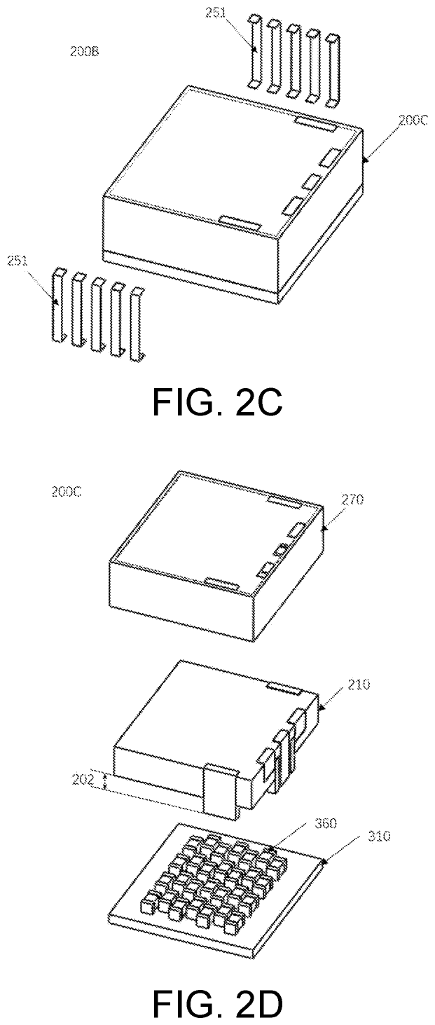

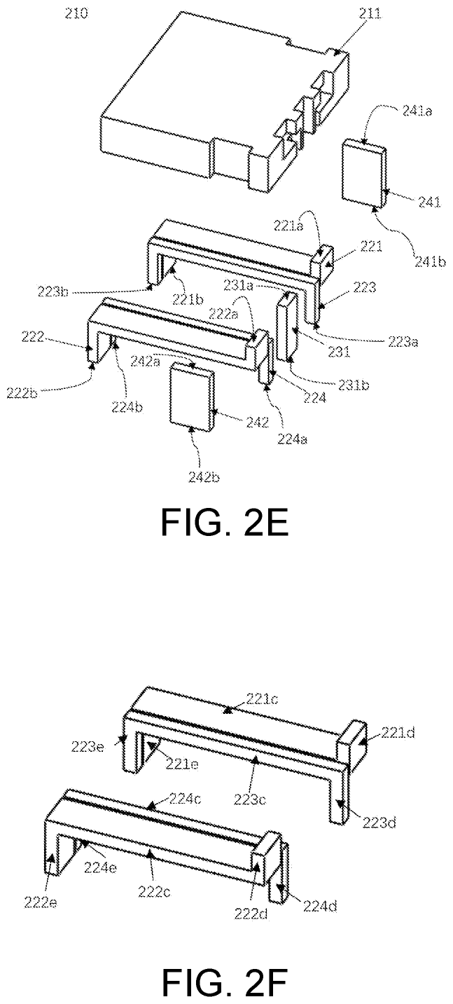

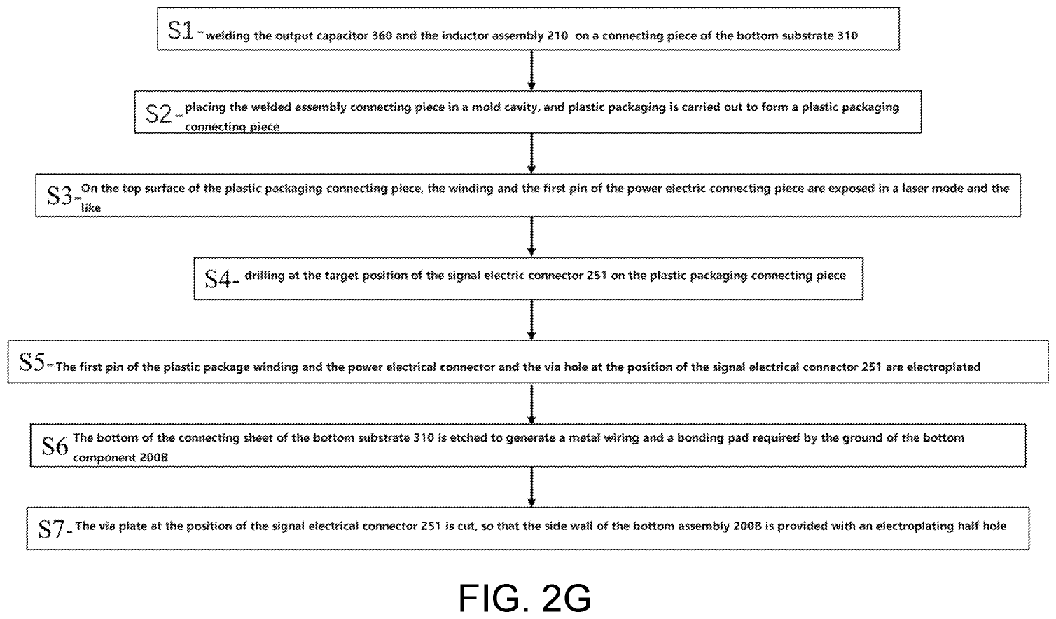

FIG. 2A shows an overall structure of the integrated power converter module according to the first embodiment of the present application, which may be a two-phase VRM module or an integral structure of a two-phase TLVR VRM module; and FIG. 2B is an exploded view of FIG. 2A. As shown in FIG. 2A and FIG. 2B, the two-phase VRM module 10 of the embodiment comprises a top assembly 100 and a bottom assembly 200B; the top assembly 100 comprises a top substrate 110, an IPM unit 121/122, an input capacitor 130, and other passive elements 140; and the IPM units 121/122 and the SW pads of the IPM units 121/122 and the SW pads of the IPM units 121/122 are arranged at a position close to a first side edge of the top plate 110, that is, a first side surface of the two-phase VRM module 10. A signal pin of the IPM unit 121/122 is arranged adjacent to a third side edge opposite to the first side edge, that is, a third side surface of the two-phase VRM module 10. Other passive elements 140 are arranged close to signal pins of the IPM unit 121/122, so as to achieve a good filtering effect; and a part of the input capacitor 130 is arranged between the IPM units 121 and 122, and the other part of the input capacitor 130 is arranged at a position adjacent to the third side edge of the top substrate 110.

FIG. 2C is an exploded view of the bottom assembly 200B in FIG. 2B; as shown in FIG. 2C, the bottom assembly 200B comprises an integrated assembly 200C and a signal electrical connector 251. The signal electrical connector 251 is arranged adjacent to the second side edge and the fourth side edge of the opposite bottom assembly 200B respectively, that is, the second side surface and the fourth side surface of the two-phase VRM module 10; and the second side surface and the fourth side surface of the two-phase VRM module 10 are located between the first side surface and the third side surface of the two-phase VRM module 10. FIG. 2D is an exploded view of the integrated assembly 200C in FIG. 2C; as shown in FIG. 2C and FIG. 2D, the integrated assembly 200C comprises a bottom substrate 310 (in some other embodiments, the bottom substrate 310 may be configured as a printed circuit board), an output capacitor 360, an inductance assembly 210, and a plastic packaging material 270. FIG. 2E is an exploded view of the inductance assembly 210; as shown in FIG. 2E, the inductance assembly 210 is the two-phase TLVR inductor shown in FIG. 1B; and with reference to FIGS. 1A and 1B, the inductance assembly 210 comprises a magnetic core 211, a first main winding 221 (L1), a first auxiliary winding 223 (L10), a second main winding 222 (L2), a second auxiliary winding 224 (L20), a VIN electrical connector 231/232, and a GND electrical connector 241/242. VIN electrical connector 231/232 and a GND electrical connector 241/242 for realizing power transmission between the bottom substrate 310 and the IPM unit 121/122.

There is no coupling relationship between the first main winding 221 and the second main winding 222, or only weak positive coupling, for example, the coupling coefficient is less than 0.2. After the first auxiliary winding 223 and the second auxiliary winding 224 are added, a strong positive coupling is provided between the first main winding 221 and the first auxiliary winding 223, for example, the coupling coefficient is greater than 0.5; and a strong positive coupling is provided between the second main winding 222 and the second auxiliary winding 224, for example, the coupling coefficient is greater than 0.5. FIG. 2F is an exploded view of each winding in FIG. 2E; referring to FIG. 2E and FIG. 2F, the first main winding 221 comprises a main body 221c, a first end part 221d, a second end part 221e, a first pin 221a connected to the first end part 221d, and a second pin 221b connected to the second end part 221e; the first pin 221a is arranged on the top surface of the magnetic core, and the second pin 221b is arranged on the bottom surface of the magnetic core or protrudes out of the bottom surface of the magnetic core. The second main winding 222 comprises a main body 222c, a first end part 222d, a second end part 222e, a first pin 222a connected to the first end part 222d, and a second pin 222b connected to the second end part 222e. The first pin 222a is arranged on the top surface of the magnetic core, and the second pin 222b is arranged on the bottom surface of the magnetic core or protrudes out of the bottom surface of the magnetic core. The first end part 221d of the first main winding 221 and the first end part 222d of the second main winding 222 are both disposed adjacent to the first side surface of the magnetic core 211, that is, the first side surface of the two-phase VRM module 10. The second end part 221e of the first main winding 221 and the second end part 222e of the second main winding 222 are both disposed adjacent to the third side surface of the magnetic core 211, that is, the third side surface of the two-phase VRM module 10. The first auxiliary winding 223 includes a main body 223c, a first end part 223d, a second end part 223e, a first pin 223a connected to the first end part 223d, and a second pin 223b connected to the second end part 223e; and the first pin 223a and the second pin 223b are arranged on the bottom surface of the magnetic core or protrude out of the bottom surface of the magnetic core. The second auxiliary winding 224 includes a main body 224c, a first end part 224d, a second end part 224e, a first pin 224 a connected to the first end part 224d, and a second pin 224b connected to the second end part 224e; and the first pin 224a and the second pin 224b are arranged on the bottom surface of the magnetic core or protrude out of the bottom surface of the magnetic core; the first end part 223d of the first auxiliary winding 223 and the first end part 224d of the second auxiliary winding 224 are both arranged adjacent to the first side surface of the magnetic core 211, and the second end part 223e of the first auxiliary winding 223 and the second end part 224e of the second auxiliary winding 224 are both arranged adjacent to the third side surface of the magnetic core 211. The VIN electric connector 231 comprises a first pin 231a and a second pin 231b, and the first pin 231a is arranged on the top surface of the magnetic core. The GND electrical connectors 241 and 242 respectively comprise a first pin 241a/242a and a second pin 241b/242b, and the first pin 241a/242a is arranged on the top surface of the magnetic core; and the second pin 241b/242b is arranged on the bottom surface of the magnetic core or protrudes from the bottom surface of the magnetic core.

The first main winding 221 and the second main winding 222 are both Z-shaped copper sheets, and the first end part 221d and the second end part 221e of the first main winding 221 respectively extend from the main body 221c to the top surface and the bottom surface of the magnetic core 211. The first end part 222d and the second end part 222e of the second main winding 222 respectively extend from the main body 222c to the top surface and the bottom surface of the magnetic core 211. The first auxiliary winding 223 and the second auxiliary winding 224 are both “[”-shaped, and the first end part 223d and the second end part 223e of the first auxiliary winding 223 respectively extend from the main body 223 to the bottom surface of the magnetic core 211. The first end part 224d and the second end part 224e of the second auxiliary winding 224 respectively extend from the main body 224 to the bottom surface of the magnetic core 211. The first auxiliary winding 223 is disposed adjacent to the first main winding 221, and the main body 223c of the first auxiliary winding 223 and the main body 221c of the first main winding 221 extend from the respective first end to the second end in the same direction. The main winding and the auxiliary winding are arranged, so that the inductance of the main winding and the inductance of the auxiliary winding are large, the external connection of the main winding and the auxiliary winding is simpler, specifically, the second end part 223e of the first auxiliary winding 223 and the first end part 224d of the second auxiliary winding 224 are short-circuited outside the inductance assembly 210, and the first end part 223d of the first auxiliary winding 223 and the second end part 224e of the second auxiliary winding 224 are respectively connected with the auxiliary winding of the other two-phase VRM module 10. The length of the main body adjacent to the main winding and the corresponding auxiliary winding is long, so that the coupling between the main winding and the corresponding auxiliary winding is good; the equivalent steady-state inductance of each phase inductor of the two-phase TLVR inductor is improved, so that the efficiency of the VRM module is kept; and meanwhile, the equivalent dynamic inductance of each phase inductor of the two-phase TLVR inductor is reduced, so that the dynamic performance of the module is improved. The inductance assembly 210 is formed by pressing iron powder or magnetic powder, that is, the non-winding area of the inductance magnetic core 211 is mainly iron powder or magnetic powder with certain magnetic conductivity (the magnetic conductivity is X); in addition, the main winding is arranged adjacent to the corresponding auxiliary winding, but the insulating distance needs to be kept between the main winding and the corresponding auxiliary winding, the insulating material is arranged, or some materials with the magnetic conductivity lower than X are arranged, so that strong coupling between the main winding and the auxiliary winding is ensured, meanwhile, electrical isolation requirements can be achieved, and it is ensured that the two-phase VRM module 10 can work reliably. A material with a magnetic permeability of X is arranged between the two-phase main windings, and a certain distance exists between the two-phase main windings, so that a weak positive coupling or no coupling relationship exists between the two main windings.

In the embodiment, both the winding and the second pin of the electrical connector protrude from the bottom surface of the magnetic core by a certain height, such as the height 202 shown in FIG. 2D. In another embodiment, the second pin of the winding and the electrical connector can also be arranged at the same height as the bottom surface of the magnetic core. In the embodiment, a height difference exists between the bottom surface of the magnetic core and the second pin, so that a certain accommodating space is formed between the magnetic core and the bottom substrate 310 and is used for arranging the output capacitor 360; the height (equivalent to the height 202) of the accommodating space is higher than the height of the output capacitor 360, and a certain space needs to be reserved between the bottom surface of the magnetic core and the upper surface of the output capacitor 360; for example, under the limit tolerance condition, a space of 0.1 mm is further formed between the bottom surface of the magnetic core and the upper surface of the output capacitor 360, and the space is used for flowing and filling of the plastic packaging material 270; and through filling of the plastic packaging material 270, the inductance assembly 210, the output capacitor 360 and the bottom substrate are effectively bonded together. In this way, even under the condition of high-temperature reflow soldering and welding spot melting, electrical connection among the three is not damaged.

The application further discloses a manufacturing process of the VRM module. The technological process is briefly described as follows: firstly, the output capacitor 360 and the inductance assembly 210 are welded on the bottom substrate 310; putting the welded assembly into a mold cavity, injecting a plastic packaging material, and carrying out plastic packaging on the assembly to form an integral integrated assembly 200C; and exposing the first pin of the winding and the power electrical connector in a laser mode and the like on the integrated assembly 200C, and electroplating on the first pin in an electroplating mode to form a first bonding pad. As shown in FIG. 2B, a first pad 221a1 of the first main winding 221 and a first pad 222a1 of the second main winding 222, a first pad 231a1 of the VIN electrical connector 231, and a first pad 241a1/242a1 of the GND electrical connector 241/242; and the upper surface and the side wall of the plastic packaging material 270 and the side wall and the lower surface of the bottom substrate 310 are electroplated to form a signal electrical connector 251, and the upper surface and the side wall of the plastic packaging material 270 and the side wall and the lower surface of the bottom substrate 310 are communicated to obtain the bottom assembly 200B. The signal electrical connector 251 is formed on the surface of the plastic packaging material 270 and the surface of the bottom substrate 310 through electroplating, and the materials of the plastic packaging material 270 and the bottom substrate 310 are all non-metal materials; before electroplating, the surface treatment before electroplating needs to be carried out at the electroplating position, wherein the surface treatment comprises roughening, oil removal, activation and the like, and then metal electroplating is carried out. Surface treatment before electroplating can effectively improve the quality of electroplating and the adhesive force of a plating layer. The signal electrical connector 151 extends from the upper surface of the plastic packaging material 270 to the side surface of the plastic packaging material 270 and then extends to the lower surface of the bottom substrate 310, so that the advantages of small occupied space and low cost of the signal electrical connector 151 are obtained. Since the lower surface of the bottom substrate is also provided with other metal wirings and bonding pads; and if the bottom substrate is directly brought together with the bottom substrate for electroplating, the acidic electroplating solution can corrode or destroy the metal wiring and the bonding pad on the bottom surface of the bottom substrate; therefore, before the signal electrical connector 251 is electroplated, the bottom metal wiring and the bonding pad of the bottom substrate need to be subjected to acid protection treatment, and after the signal electrical connector 251 is electroplated, the metal wiring and the bonding pad at the bottom of the bottom substrate are restored and weldable.

In another preferred embodiment, the metal wiring and the bonding pad on the bottom surface of the bottom substrate can be realized without a PCB process, that is, the bottom surface of the bottom substrate 310 is free of a metal wiring and a bonding pad, and the metal wiring and the bonding pad actually needed at the bottom surface of the bottom substrate are realized together in an electroplating mode when the signal electrical connector 251 is electroplated.

According to the process flow, the signal electrical connector 251 is realized on the basis of the integrated assembly 200C of the monomer.

In order to shorten the production time, the production efficiency is improved, and the method can also be operated in a connecting mode. The detailed steps of the method are as shown in FIG. 2G, and the specific steps are as follows:
Step S1: welding an output capacitor 360 and an inductance assembly 210 on a connecting piece of a bottom substrate 310;
Step S2, putting the welded assembly connecting piece into a mold cavity, injecting a plastic packaging material, and carrying out plastic packaging on the welded assembly to form a plastic packaging connecting piece;
Step three, S3, exposing a first pin of the winding and the power electric connector in a laser mode and the like on the top surface of the plastic packaging connecting piece;
S4, drilling a target position and a drill hole of the signal electric connector 251 on the plastic packaging connecting piece;
S5, electroplating a first pin of the plastic package winding and the power electrical connector and a via hole in the position of the signal electrical connector 251;
S6, etching the bottom of the connecting piece of the bottom substrate 310 to generate a metal wiring and a bonding pad required by the bottom surface of the bottom assembly 200B;

In a seventh step S7, a via hole is cut along the position of the signal electrical connector 251 to obtain a bottom assembly 200B with an electroplating half hole on the side wall. The electroplating half hole implements the function of the signal electrical connector 251 on the bottom assembly 200B.

Referring to FIG. 2B, the signal electrical connector 251 is respectively disposed on the second side surface and the fourth side surface opposite to the bottom component 200B, that is, the second side surface and the fourth side surface of the two-phase VRM module 10, and is close to the third side surface adjacent to the second pin 221b/222b of the main winding; the second pin 221b/222b of the main winding is the output of the VRM module, and the voltage Vo of the main winding is a relatively static potential; the first pin 221a/222a of the main winding is connected with the SW pad of the corresponding IPM unit, the point is a potential point for rapid voltage jump, and the rapid jump voltage is easy to cause electric field interference; therefore, the signal electrical connector is arranged at the second pin close to the main winding, so that the electric field interference of the signal electrical connector 251 caused by the rapid change of the voltage of the first pin 221a/222a of the main winding can be reduced.

Referring to FIG. 2A and FIG. 2B, after the IPM units 121/122, the capacitors 130, and the passive elements 140 in the top assembly 100 are welded to the top surface of the top substrate 110, the bottom surface of the top substrate 110 of the top assembly 100 and the top surface of the bottom assembly 200B are welded together to obtain a complete two-phase VRM module 10. Only the top surface and the bottom surface of the top substrate 110 are exposed, and the welding points on the bottom assembly 200B are covered by the plastic packaging material 270, so that the number of welding points exposed outside is greatly reduced, and the reliability of electrical connection during reflow soldering of the two-phase VRM module is improved.

The first pads 221a1/222a1 of the main winding are respectively close to the SW pads of the IPM units 121/122, respectively; the first pads 241a1/242a1 of the GND electrical connectors are respectively close to the GND pads of the IPM units 121/122. Because the current flowing through the main winding and the current flowing through the GND electrical connector are both large currents, the first bonding pads 221a1/222a1 of the main winding are vertically connected with the SW bonding pads of the IPM nearby, or the first bonding pads 241a1/242a1 of the GND electrical connectors are vertically connected with the GND pads of the IPM, so that the loss caused by the transverse current of the top substrate 110 can be reduced, and the efficiency of the VRM module is improved.

The VIN electrical connector 231 and the GND electrical connector 241/242 in the first embodiment disclosed by the application are both rectangular copper columns and are similar to the main winding 221/222, the two ends of the VIN electrical connector 231 are respectively provided with a first pin 231a and a second pin 231b, the direct-current impedance of the rectangular copper columns of the first pins 241a/242a and the second pin 241b/242b is low, the direct-current conduction loss is low, and the conversion efficiency of the VRM module is improved. In other embodiments, the VIN electrical connector and the GND electrical connector can also be cylindrical; and the cylindrical copper column is easy to be integrally formed with the magnetic core 211, so that the manufacturing process is simplified, and the reliability of the VRM module is improved. And is not limited thereto.

Referring to the structure of the VRM module and FIG. 1A and FIG. 1B, the VIN electrical connector 231/232, the input capacitor Cin and the GND electrical connector 241/242 have parasitic inductance, and the presence of the parasitic inductance can form resonance with the input capacitor Cin. When the resonant frequency is close to the equivalent switching frequency of the VRM, the current amplitude flowing through the parasitic inductor is greatly increased, so that the normal work of the VRM module is interfered, and the conversion efficiency of the VRM module is reduced. Here, if the PWM phases of the IPM units 121 and 122 are the same, the equivalent switching frequency of the two-phase VRM module 10 is equal to the switching frequency of the IPM; and if the PWM phases of the IPM units 121 and 122 differ by 180 degrees, the equivalent switching frequency of the two-phase VRM module 10 is equal to twice the switching frequency of the IPM. In the embodiment, the VIN electrical connector 231 and the GND electrical connector 241/242 are arranged on different side surfaces, that is, the VIN electrical connector is arranged on the first side surface of the magnetic core 211 (which can also be arranged on the third side surface of the magnetic core 211 in another embodiment), and the GND electrical connector is respectively arranged on the second side surface and the fourth side surface of the magnetic core 211. In this way, the parasitic inductance in the power input loop can be improved, so that the resonant frequency between the parasitic inductance and Cin is reduced, the resonant frequency is far lower than the equivalent switching frequency of the two-phase VRM module 10, the influence of the resonance on the efficiency of the VRM module is reduced, and the conversion efficiency of the VRM module is improved.

The bottom substrate 310 of the bottom assembly 200B is a bottom wiring conversion layer and is used for rearranging the bottom pins of the VRM module 10, so that the top surface pin layout of the substrate 310 is different from the bottom surface pin layout, and the requirements of industrial standardized pin layout or customer customized packaging pin layout are met. In addition, the capacitor element 360 is located between the inductance assembly 210 and the bottom substrate 310, so that the capacitor element 360 is closer to the load, thereby reducing parasitic parameters in the capacitor element 360 and the load circuit; and when the load current rapidly jumps, the capacitor element 360 can quickly provide energy to the load, thereby ensuring the stability of the output voltage, thereby satisfying the dynamic performance of the output voltage of the VRM module 10.

### Embodiment 2

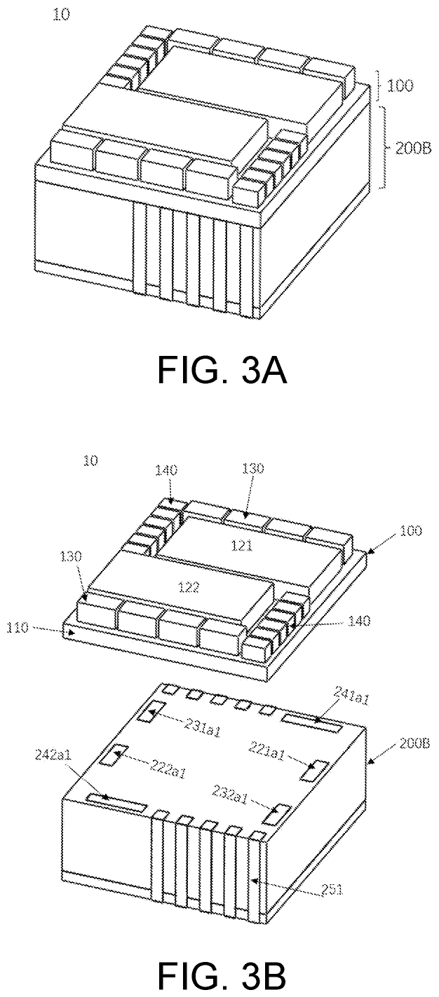

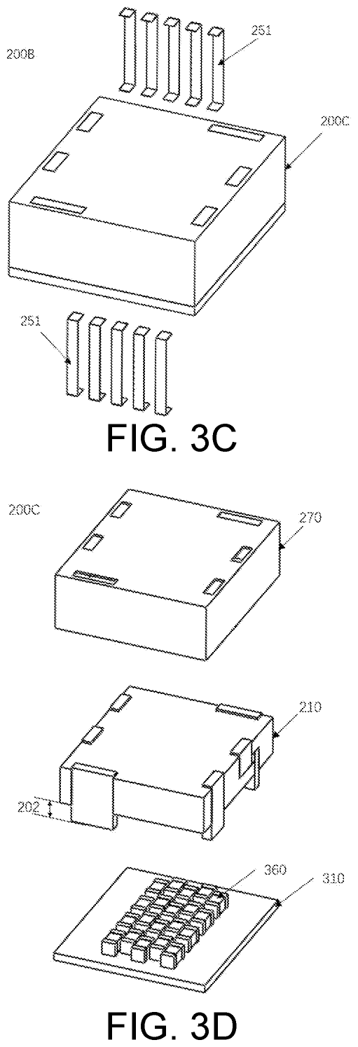

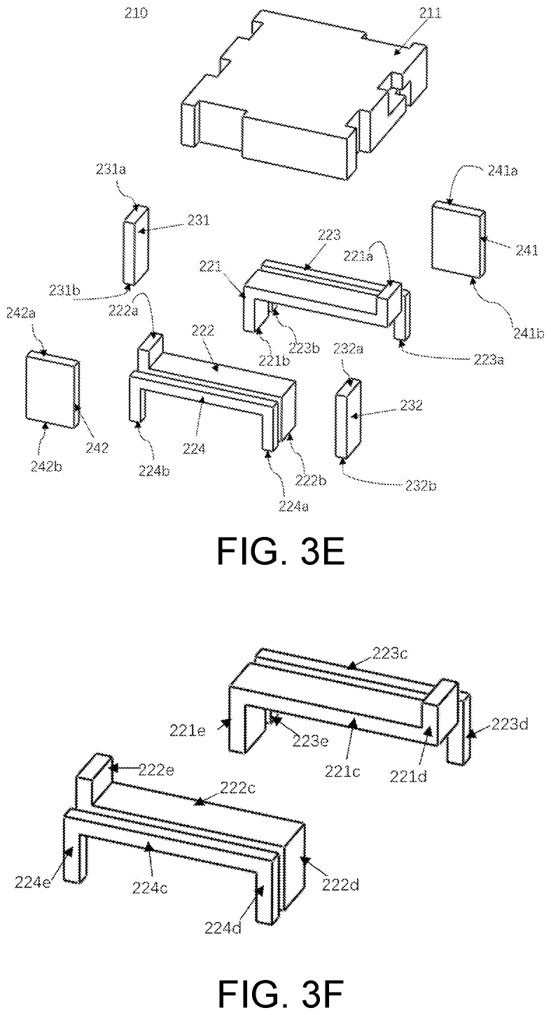

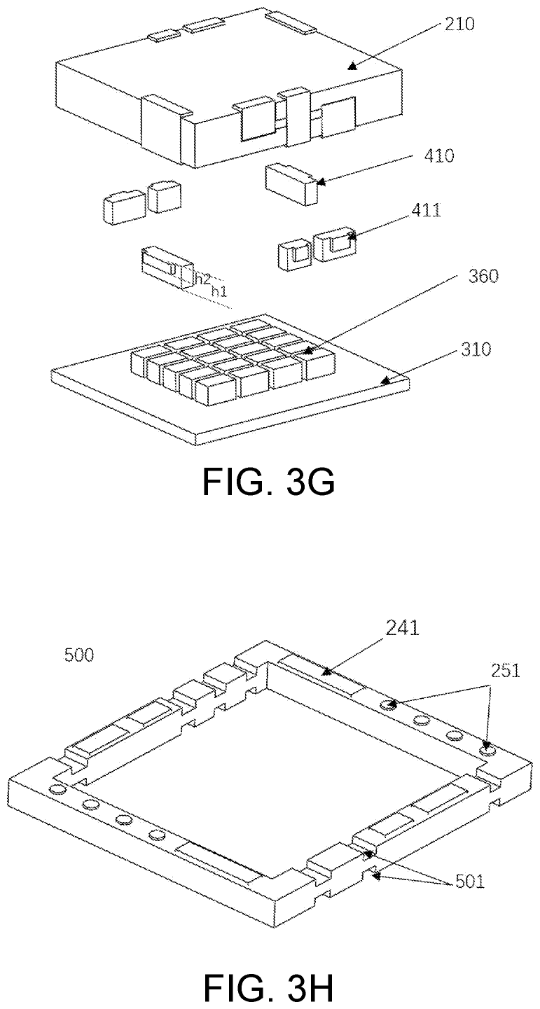

FIG. 3A shows an overall structure of the integrated power converter module according to the second embodiment of the present application, which may be a two-phase VRM module or an integral structure of a two-phase TLVR VRM module; and FIG. 3B is an exploded view of FIG. 3A. As shown in FIG. 3A and FIG. 3B, the two-phase VRM module 10 of the embodiment comprises a top assembly 100 and a bottom assembly 200B. The top assembly 100 comprises a top substrate 110, an IPM unit 121/122, an input capacitor 130 and other passive elements 140. The top assembly 100 in the embodiment has the same technical effect as the top assembly 100 in the first embodiment, the difference is that the positions of the parts on the top assembly are different, and the first IPM unit 121 and the SW bonding pad thereof are close to the first side edge of the top assembly 100, that is, the first side surface of the two-phase VRM module 10 is placed; the second IPM unit 122 and the SW pad of the second IPM unit 122 are close to the third side edge of the top assembly 100, that is, the third side surface of the two-phase VRM module 10 is placed; the input capacitor 130 is adjacent to the second side edge and the fourth side edge of the top assembly 100, that is, the second side surface and the fourth side surface of the two-phase VRM module 10 are arranged. The other passive elements 140 are arranged adjacent to the first side surface and the third side surface of the two-phase VRM module 10 respectively, and the passive elements 140 are arranged adjacent to the two IPM units respectively. The layout can enable the first pads 221a/222a of the main windings 221/222 to be vertically connected with the SW pads of the IPM units nearby, so that the loss caused by the transverse current of the top substrate 110 is reduced, and the conversion efficiency of the VRM module is improved.

FIG. 3C is a structural exploded view of the bottom assembly 200B, FIG. 3D is a structural exploded view of the integrated assembly 200C in FIG. 3C, FIG. 3E is a structural exploded view of the inductive assembly 210 in FIG. 3D, and FIG. 3F is a structural exploded view of each winding in FIG. 3E. According to the embodiment, the overall structure and the implementation mode are basically the same, one difference is the layout of the main winding in the inductance assembly 210, and in the inductance assembly 210 in the embodiment, the first main winding 221 and the second main winding 222 are both copper sheets in the “Z”-shape. The difference lies in that the first end part 221d of the first main winding 221 is arranged adjacent to the first side surface of the two-phase VRM module 10, and the second end part 221e is arranged adjacent to the third side surface of the two-phase VRM module 10; the second end part 221e extends downwards along the third side surface of the two-phase VRM module 10 (ie, the first main winding and the second main winding are arranged in a second-order rotation symmetry mode); in other embodiments, the second end part 221e can also not be exposed to the third side surface of the two-phase VRM module 10, but extends downwards through the lower bottom plate of the magnetic core 211. The first end part 222d of the second main winding 222 is arranged adjacent to the third side surface of the two-phase VRM module 10, and the second end part 222e is arranged adjacent to the first side surface of the two-phase VRM module 10; the second end part 222e extends downwards along the first side surface of the two-phase VRM module 10. In other embodiments, the second end part 222e can also not be exposed to the first side surface of the two-phase VRM module 10, but extends downwards through the lower bottom plate of the magnetic core 211. According to the arrangement mode of the first main winding 221 and the second main winding 222, reverse coupling between the first main winding 221 and the second main winding 222 is achieved, and the advantage that the equivalent dynamic inductance of the main winding is smaller than the equivalent steady-state inductance is obtained.

The first auxiliary winding 223 and the second auxiliary winding 224 are both “[”-shaped, and the structures of the first auxiliary winding 223 and the second auxiliary winding 224 in the first embodiment are basically the same; the first auxiliary winding 223 is arranged adjacent to the first main winding 221, and the second auxiliary winding 224 is arranged close to the second main winding 222; and the difference lies in that the first auxiliary winding 223 and the second auxiliary winding 224 are respectively arranged on the outer sides of the first main winding 221 and the second main winding 222. An extension direction of the main body 221c of the first main winding 221 from the first end part 221d to the second end part 221e is the same as an extension direction of the main body 223c of the first auxiliary winding 223 from the first end part 223d to the second end part 223e; the extending direction of the main body 222c of the second main winding 222 from the first end part 222d to the second end part 222e is opposite to the extending direction of the main body 224c of the second auxiliary winding 224 from the first end part 224d to the second end part 224e; so that the specific mode that the auxiliary winding is short-circuited outside the inductance assembly 210 is different from that of the first embodiment, specifically, the second end part 223e of the first auxiliary winding 223 and the second end part 224e of the second auxiliary winding 224 are short-circuited outside the inductance assembly 210, instead of being short-circuited with the first end part 224d of the second auxiliary winding 224 in the outside of the inductance assembly 210. According to the layout arrangement of the main winding and the auxiliary winding, the inductance of the main winding and the auxiliary winding can also be large, the main winding and the auxiliary winding are long in length, so that the coupling between the main winding and the corresponding auxiliary winding is good, the equivalent steady-state inductance of each phase inductor of the two-phase TLVR inductor is guaranteed, and the conversion efficiency of the VRM module is kept; and meanwhile, the equivalent dynamic inductance of each phase inductor of the two-phase TLVR inductor can be reduced, so that the dynamic performance of the VRM module is improved. Due to the arrangement of the winding, on the basis of the two-phase TLVR inductor, the first main winding 221 and the second main winding 222 meet the anti-coupling relation, so that the advantage that the equivalent dynamic inductance of the main winding is further smaller than the equivalent steady-state inductor is obtained. In the embodiment, the second end part 223e of the first auxiliary winding and the second end part 224e of the second auxiliary winding extend downwards along the third side surface and the first side surface of the two-phase VRM module 10 respectively; in other embodiments, the second end part 223e of the first auxiliary winding and the second end part 224e of the second auxiliary winding can also not be exposed to the third side surface and the first side surface of the two-phase VRM module 10, but extend downwards along with the lower bottom plate penetrating through the magnetic core 211 by the main winding.

Meanwhile, an insulating material is arranged between the first main winding 221 and the second main winding 222, or some materials with the magnetic permeability lower than X are arranged, so that the two-phase main winding has stronger magnetic coupling; the currents in the two-phase main windings flow in from the first pins of the top surface, the current directions of the main bodies flowing through the main winding are opposite, and the magnetic fluxes cancel each other, that is, the two-phase main winding works in a stronger anti-coupling state; and strong reverse coupling between the main windings can further pull the difference between the equivalent steady-state inductance and the equivalent dynamic inductance of each phase of inductor.

### Embodiment 3

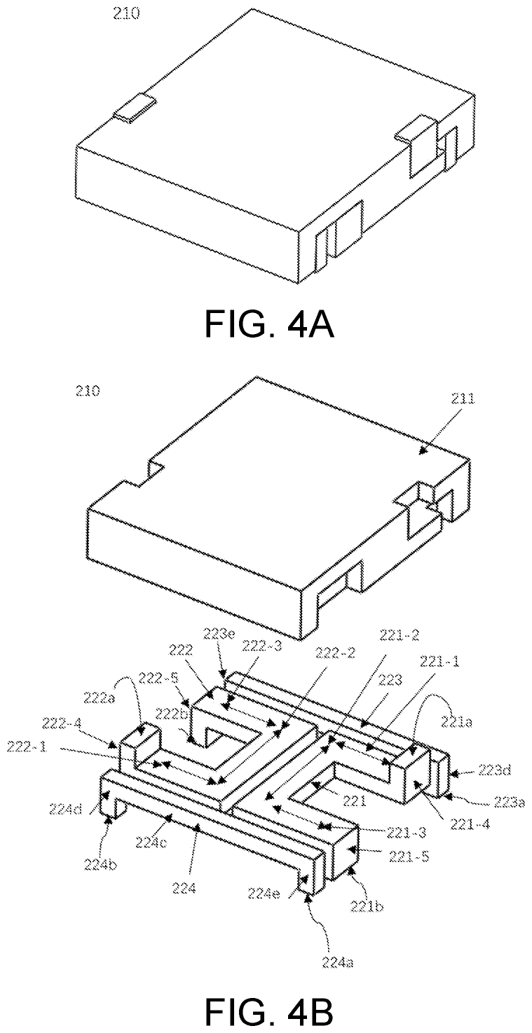

FIG. 4A shows another embodiment of the inductance assembly 210 in the embodiment of the application; only the inductive magnetic core 211 and the main winding 221/222 and the auxiliary winding 223/224 are shown, and the power connector is not shown. As shown in FIG. 4B, the inductance assembly comprises a magnetic core 211, a first main winding 221, a second main winding 222, a first auxiliary winding 223 and a second auxiliary winding 224; and the first main winding 221 and the second main winding 222 are all horizontally placed “ [symbol] ”-shaped windings, the first main winding 221 comprises a first pin 221a, a second pin 221b, a first main body 221-1, a second main body 221-2, a third main body 221-3, a first end part 221-4 connected to the first pin 221a, and a second end part 221-5 connected to the second pin 221b. The first pin 221a and the second pin 221b are both adjacent to the first side surface of the magnetic core; the first pin 221a is provided on the top surface of the magnetic core; and the second pin 221b is provided on the bottom surface of the magnetic core or protrudes from the bottom surface of the magnetic core; and the first end part 221-4 and the second end part 221-5 are partially exposed out of the first side surface. The second main winding 222 includes a first pin 222a, a second pin 222b, a first body 222-1, a second body 222-2, a third body 222-3, a first end part 222-4 connected to the first pin 222a, and a second end part 222-5 connected to the second pin 222b. The first pin 222a is disposed on the top surface of the magnetic core, and the second pin 222b is disposed on the bottom surface of the magnetic core or protrudes from the bottom surface of the magnetic core; and the first end part 222-4 and the second end part 222-5 are partially exposed to the third side surface (equivalent to the first main winding and the second main winding being arranged in a second-order rotation symmetry manner). The first pin 221a/222a is electrically connected to a corresponding IPM unit SW pad upwards; and the second pin 221b/222b is electrically connected to a load downwards.

The inductance assembly 210 is formed by pressing iron powder or magnetic powder, that is, the non-winding area of the inductance magnetic core 211 is mainly iron powder or magnetic powder with certain magnetic conductivity, for example, a material with the magnetic conductivity of X. The second main body 221-2 of the first main winding 221 and the second main body 222-2 of the second main winding 222 are adjacently arranged, but the insulating distance needs to be kept between the second main body 221-2 and the second main winding 222, the insulating material is arranged, or some materials with the magnetic conductivity lower than X are arranged, so that electrical insulation between the two windings is realized, and the coupling coefficient between the two main windings is improved. The current flowing through the second main body of the two main windings is opposite, so that the magnetic flux generated by the current flowing through the second main body is mutually counteracted; so that the second main body of the two main windings works in an anti-coupling state; but the first main body of the first main winding 221 and the third main body of the second main winding 223 are in a positive coupling state, and the third main body of the first main winding 221 and the second main winding 223 or the first main body are also in a positive coupling state. The structure of the first main winding 221 and the second main winding 223 and the arrangement mode of first positive coupling and then reverse coupling and then positive coupling, so that the steady-state equivalent inductance of each main winding of the inductance assembly 210 is greater than the dynamic equivalent inductance.

The first auxiliary winding 223 is arranged adjacent to the first main body 221-1 of the first main winding 221 and the third main body 222-3 of the second main winding 222, and only an insulating material or a material with the magnetic conductivity lower than X is arranged between the first auxiliary winding 223 and the two-phase main winding, so that electrical insulation between the windings is realized, and the coupling coefficient between the auxiliary winding and the main winding is improved. The first auxiliary winding 223 comprises a main body 223c, a first end part 223d, a second end part 223e, a first pin 223a connected with the first end part 223d and a second pin 223b connected with the second end part 223e, the first end part 223d and the second end part 223e extend from the main body 223c to the bottom surface of the magnetic core 211, and the first pin 223 a and the second pin 223 b are arranged on the bottom surface of the magnetic core or protrude out of the bottom surface of the magnetic core; current flowing through the first auxiliary winding 223 flows from the first pin 223a to the second pin 223b, so that the current flowing through the first auxiliary winding 223 is the same as the current direction flowing through in the first main body 221-1 the first main winding 221 and the current direction flowing through the third main body 222-3 of the second main winding 222, and the magnetic flux is mutually enhanced, so that the first auxiliary winding 223 is positively coupled with the two-phase main winding 221/222.

The second auxiliary winding 224 is arranged adjacent to the third main body 221-3 of the first main winding 221 and the first main body 222-1 of the second main winding 222, and only an insulating material or a material with the magnetic permeability lower than X is arranged between the second auxiliary winding and the two-phase main winding, so that electrical insulation between the windings is realized, and the coupling coefficient between the auxiliary winding and the main winding is improved. The second auxiliary winding includes a main body 224c, a first end part 224d, a second end part 224e, a first pin 224a connected to the first end part 224d, and a second pin 224b connected to the second end part 224e. The first end part 224d and the second end part 224e extend from the main body 224c to the bottom surface of the magnetic core 211, and the first pin 224a and the second pin 224b are arranged on the bottom surface of the magnetic core or protrude out of the bottom surface of the magnetic core; current flowing through the second auxiliary winding 224 flows from the second pin 224b to the first pin 224a, so that the current flowing through the second auxiliary winding 224 is the same as the current direction flowing through the third main body 221-3 of the first main winding 221 and the current direction flowing through the first main body 222-1 of the second main winding 222, and the magnetic flux is mutually enhanced, so that the second auxiliary winding 224 is positively coupled with the two-phase main winding 221/222.

The first auxiliary winding 223 and the second auxiliary winding 224 can be connected in series firstly, and then are connected in series with auxiliary windings or compensation inductors Le of other two-phase VRM modules to form a closed loop, so that the function of the two-phase TLVR inductor is realized. Specifically, the second end part 223e of the first auxiliary winding 223 is connected in series with the first end part 224d of the second auxiliary winding 224. In another extended embodiment, the first auxiliary winding 223 and the second auxiliary winding 224 can be connected in parallel, and then the first auxiliary winding 223 and the second auxiliary winding 224 are connected in series with the auxiliary winding or the compensation inductor Le of the other two-phase VRM module to form a closed loop, so that the function of the two-phase TLVR inductor is realized. Specifically, the first end part 223d of the first auxiliary winding 223 is shorted to the first end part 224d of the second auxiliary winding 224, and the second end part 223e of the first auxiliary winding 223 is shorted to the second end part 224e of the second auxiliary winding 224.

According to the two-phase TLVR inductor in the embodiment shown in FIG. 3A and FIG. 4A, the two-phase main winding of the two-phase TLVR inductor works in an anti-coupling state; in some embodiments, the auxiliary winding can be not arranged, the two-phase main winding is only used as two opposite coupling inductors, so that relatively low dynamic inductance and relatively high steady-state inductance are realized, the dynamic performance is considered, meanwhile, the steady-state efficiency is considered. The manufacturing difficulty of the inductor can be reduced, and the cost of the inductor can be saved.

The embodiment shown in FIG. 3C is further extended, as shown in FIG. 3G. Different from FIG. 3C, the inductance assembly 210 and the bottom substrate 310 are connected through the copper column 410. The process flow is briefly described as follows:
Step 1, preparing an inductance assembly 210, wherein the inductance assembly 210 comprises a magnetic core 211, a main winding and/or an auxiliary winding, a VIN electrical connector and a GND electrical connector; pins of the inductance winding and pins of the connectors are close to the top surface or the bottom surface of the magnetic core at the same height;
In Step 2, the inductance assembly 210 is welded to the connecting frame. The frame comprises a plurality of units, each unit comprises all the copper columns 410 in FIG. 3G, the units are connected into a whole through connecting ribs 411, and the thickness of the connecting ribs 411 is about ⅓-⅔ of the thickness h1 of the copper columns 410.
In Step 3, the connecting piece frame is cut and separated from the position of the connecting rib 411 to obtain independent unit bodies, that is, the inductance assembly 210 shown in FIG. 3G and the copper column 410 are connected to form a whole.
Step 4, the unit body formed in Step 3 and the output capacitor 360 are attached to the bottom substrate 310 together, and the bottom substrate 310 is of a connecting plate structure; and through the process, a plurality of unit bodies formed in Step 3 are welded to the surface of the bottom substrate.
Step 5, integrally plastic packaging is carried out on the Step 4, then a signal pin is formed through a drilling and metallization process, the signal pin extends from the top surface of the inductance assembly to the bottom surface of the bottom substrate, and finally, the appearance structure shown in FIG. 3C is formed through the plate.

Optionally, in Step 5, a required metal wiring and a bonding pad structure are formed on the bottom substrate 310 by means of an etching process before the board is split.

According to the embodiment, by introducing the connecting piece metal frame, on one hand, the manufacturing process of the inductance assembly 210 can be simplified, and batch production is met; and on the other hand, due to the fact that the sectional area of the copper column is large, the conduction impedance can be effectively reduced.

The connecting sheet metal frame shown in FIG. 3H is a deformed form of the connecting sheet metal frame in FIG. 3G. The substrate 500 can be realized by a process of embedding a metal block in a printed circuit board (PCB), and can also be realized by a metal block adding metallization process. The structure at least comprises a power pin 241, and the function of the copper column in FIG. 3G is achieved. The substrate 500 may include a signal pin 251 in addition to the power pin 241, so that the signal pin 251 and the power pin 241 are integrated on one substrate, and sufficient flatness can be ensured. Meanwhile, the spacing between the signal pins can be small enough to meet the requirements of high-density wiring due to the fact that a metal block or a plastic packaging metal block is embedded into the PCB and a metallization process is added. Meanwhile, in order to meet the requirements of module plastic packaging, the substrate 500 can also comprise a plurality of depth control grooves 501, the depth control grooves 501 are located on the upper surface and the lower surface of the substrate and used for providing a mold flow channel for the plastic material when the plastic bottom sealing part module 200B is used.

### Embodiment 4

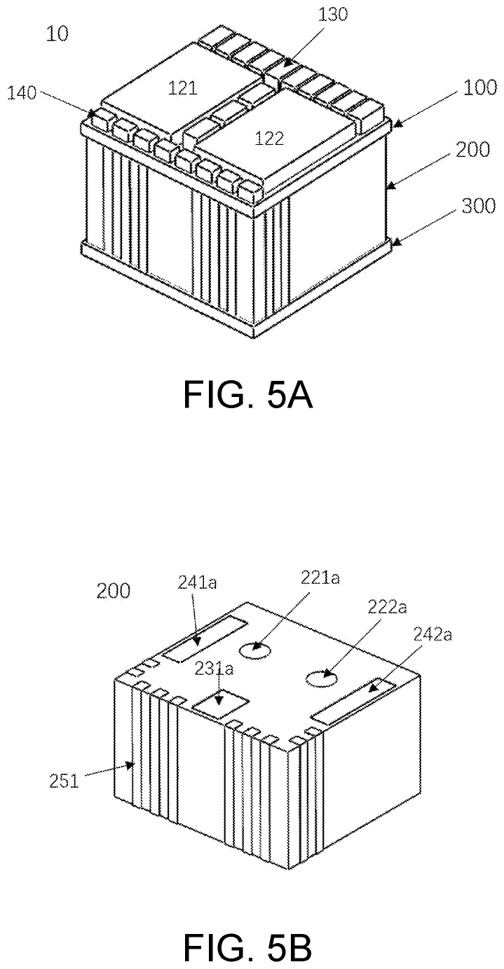

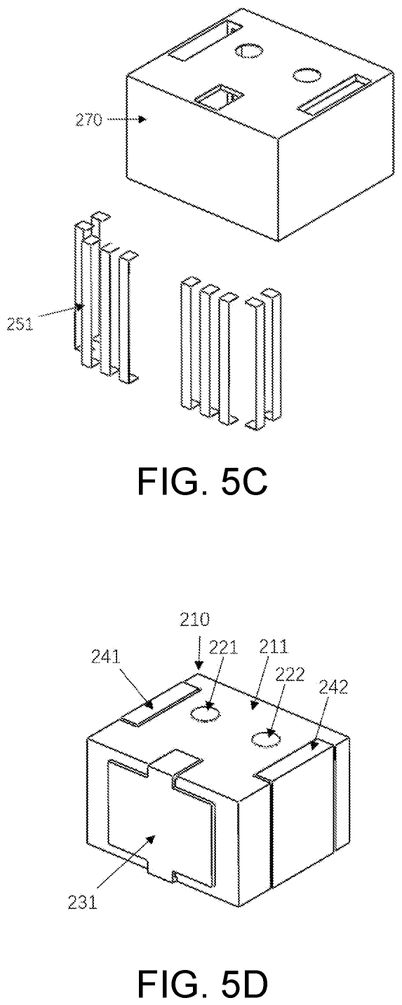

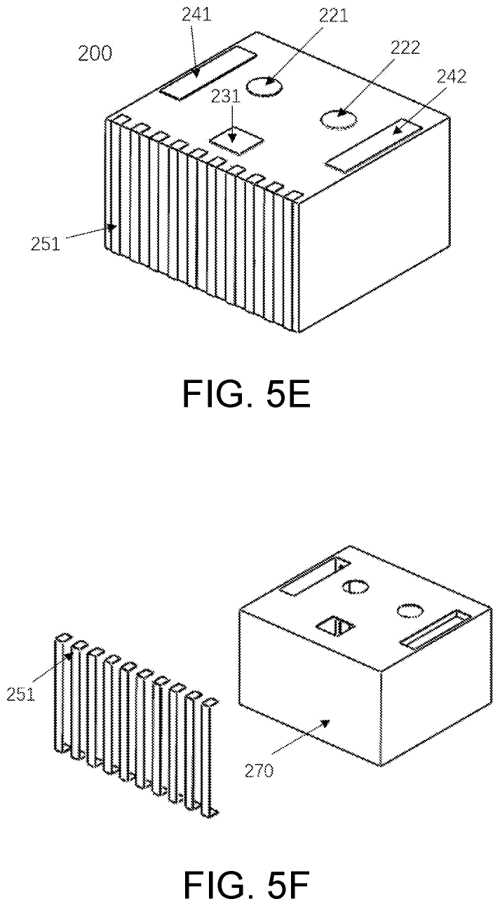

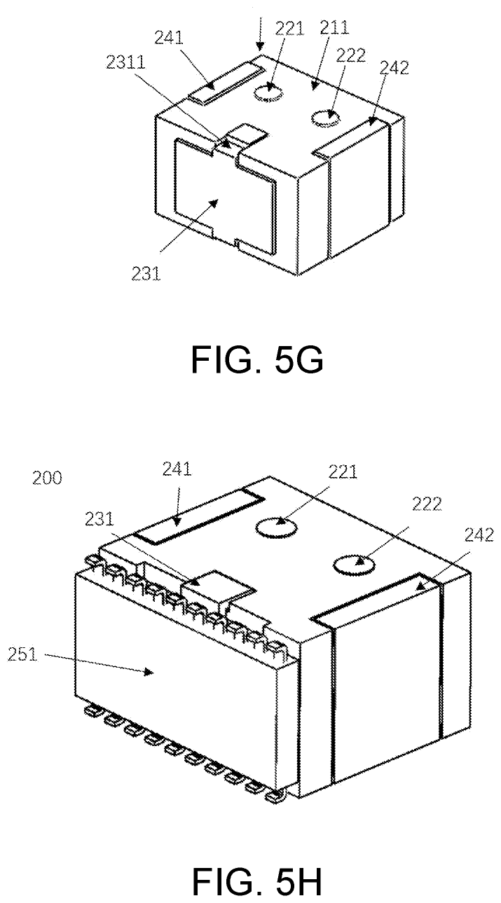

As shown in FIG. 5A, the VRM module 10 includes a top assembly 100, an integrated inductor 200, and a bottom substrate 300. The top substrate 100 has the same technical effect as the embodiment shown in FIG. 2A, the bottom substrate 300 only serves as an adapter plate of the output pins of the VRM module so as to meet the requirements of different customers and different application scenes; and the problem mainly solved by the embodiment is that the anti-interference capability of the signal on the integrated inductor 200 is further enhanced.

FIG. 5B is a schematic structural diagram of the integrated inductor 200 in FIG. 5A, FIG. 5C is a structural exploded view of FIG. 5B, and FIG. 5D is a schematic structural diagram after the plastic packaging material is removed. As shown in FIGS. 5B, 5C and 5D, the integrated inductor 200 comprises a magnetic core 211, a first main winding 221, a second main winding 222, a VIN electrical connector 231, a GND electrical connector 241/242, a plastic packaging material 270, and a signal electrical connector 251. The first main winding 221 and the second main winding 222 are I-shaped copper columns, the first main winding 221 comprises a first pin 221a, a second pin 221b (not shown) and a main body 221c (not shown), the first pin 221a is arranged on the top surface of the magnetic core, the second pin 221b is arranged on the bottom surface of the magnetic core, the main body 221c extends from the top surface of the magnetic core to the bottom surface of the magnetic core, and the first main winding 221 is arranged adjacent to the first side surface of the magnetic core; the second main winding 222 comprises a first pin 222a, a second pin 222b (not shown) and a main body 222c (not shown), the first pin 222a is arranged on the top surface of the magnetic core, the second pin 222b is arranged on the bottom surface of the magnetic core, the main body 222c extends from the top surface of the magnetic core to the bottom surface of the magnetic core, and the second main winding 222 is arranged adjacent to the first side surface of the magnetic core. The VIN electrical connector 231 is disposed adjacent to a third side of the magnetic core, and the GND electrical connector 241/242 is disposed adjacent to the second side surface and the fourth side surface of the magnetic core, respectively. After the magnetic core 211, the first main winding 221, the second main winding 222, the VIN electrical connector and the GND electrical connector are integrally pressed or assembled, plastic packaging materials 270 are packaged together, then pins of the first pins and the second pins of the winding and pins of the VIN electrical connector and the GND electrical connector are exposed on the top surface and the bottom surface of the plastic packaging material, for example, through processes such as laser and the like, the bonding pads are electroplated on the exposed pins in an electroplating mode; and meanwhile, the signal electrical connector 251 is electroplated on the plastic packaging material 270, and specifically, the signal electrical connector 251 reaches the bottom surface from the top surface of the plastic packaging material 270 along the side surface. The signal electrical connector 251 and the magnetic core 211 are separated by a plastic packaging material 270 and a VIN electrical connector 231; and the width of the VIN electrical connector between the top surface pin and the bottom surface pin is larger than the width of the pin. Therefore, the main winding is an I-shaped copper column, and parasitic capacitance exists between the main winding and the signal electrical connector, so that the rapidly changing voltage on the winding is easily coupled to the signal electrical connector through the parasitic capacitor, and the signal transmission quality and the normal work of the VRM module are influenced. According to the application, the middle portion of the VIN electrical connector 231 is widened, then the signal electrical connector 251 is electroplated on the plastic packaging material 270 through a plastic packaging process, and the signal electrical connector 251 is separated from the main winding through the plastic packaging material 270 and the VIN electrical connector. Therefore, the VIN electrical connector 231 serving as a relatively static potential plays a role of a shielding layer, and the electric field interference of the main winding on the signal electrical connector 251 is shielded; and the signal quality of the VRM module and the reliability of the module are improved. It should be noted that the width of the middle portion of the VIN electrical connector needs to cover the signal electrical connector that needs to be shielded; and the signal electrical connector that does not need to be shielded may be provided on the second side or the fourth side of the magnetic core.

FIG. 5E is another preferred solution of the integrated inductor 200 of the present embodiment, FIG. 5F is an exploded view of the structure of FIG. 5E, and FIG. 5G is a schematic structural diagram after the plastic packaging material is removed. As shown in FIG. 5E, FIG. 5F and FIG. 5G, the embodiment of the application has the same technical effect as the integrated inductor 200 in the embodiment shown in FIG. 5A, and the difference lies in that the structure of the VIN electrical connector is different. As shown in FIG. 5G, the VIN electrical connector 231 is arranged on the top surface, the bottom surface and the third side surface of the magnetic core; a step 2311 is arranged between the pin arranged on the top surface or the bottom surface and the middle part of the third side surface, and the height of the step 2311 is lower than the height of the top surface or the bottom surface of the magnetic core; and after plastic packaging is carried out through the plastic packaging material 270, so that the plastic packaging material on the step 2311 can also be used for arranging the signal electrical connector, so that the third side surface has a wider width and is used for arranging the signal electrical connector 251, that is, the VIN electrical connector 231 can cover more signal electrical connector, so that a better shielding effect is achieved; and meanwhile, the signal electrical connector 251 is only arranged on the same side surface of the magnetic core, namely the third side surface, the advantage is that the pretreatment process before electroplating is simple, and the cost can be reduced.

FIG. 5H is another preferred solution of the integrated inductor 200 of the present embodiment, and FIG. 5I is an exploded view of the structure of FIG. 5H. As shown in FIG. 5H and FIG. 5I, the embodiment is the same as the integrated inductor 200 in the embodiment shown in FIG. 5A, and the difference lies in that the signal electrical connector 251 is of a pin hearder structure and is assembled on the third side surface of the magnetic core through glue bonding; the middle portion of the VIN electrical connector 231 is also widened compared with the pin part, and the shielding effect of the VIN electrical connector on the signal electrical connector 251 of the pin header structure can also be achieved, so that the electric field interference generated by the main winding on the signal electrical connector is eliminated, and the signal on the signal electric connector 251 is reliably transmitted and operated; and meanwhile, the assembling mode of assembling the needle discharging adhesive on the magnetic core in a bonding mode, the plastic packaging process can be omitted, and the cost of the VRM module can be reduced; and furthermore, the pin header assembly mode is large in welding area, good in welding strength and good in assembly reliability when being assembled with the mainboard.

### Embodiment 5

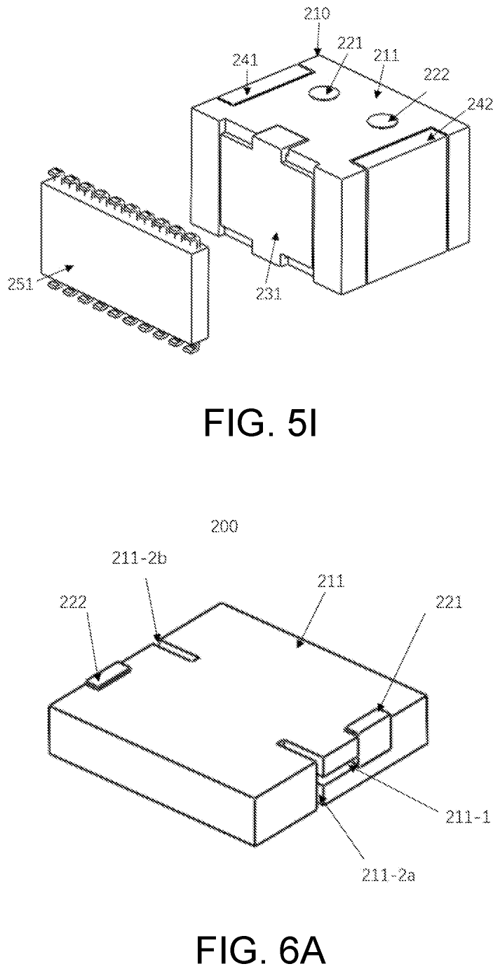

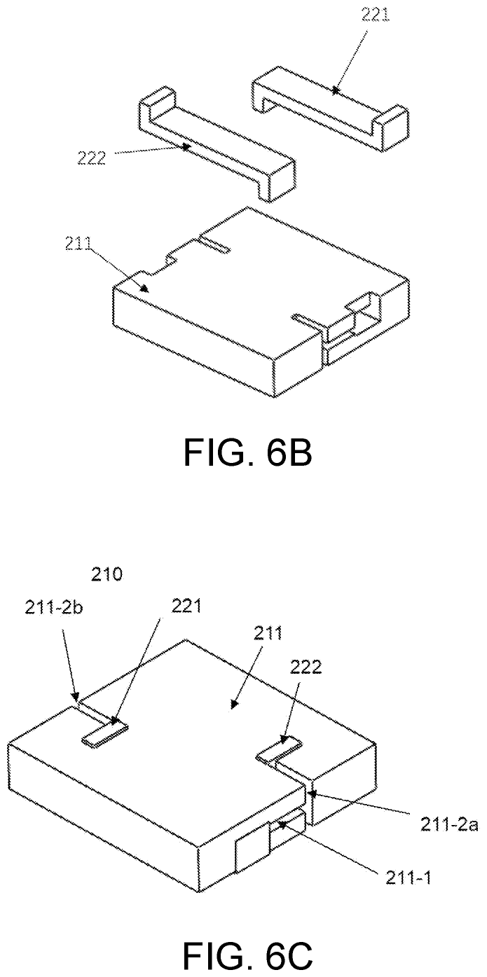

The application further discloses another embodiment of the inductance assembly, the inductance assembly 200 shown in FIG. 6A to 6C is an implementation schematic diagram of the inductor 200 shown in FIG. 1A. FIG. 6A is a top view of the inductance assembly 200, FIG. 6B is a structural exploded view of FIG. 6A, and FIG. 6C is a bottom view of the inductance assembly 200. With reference to FIG. 6A and FIG. 6B, the inductor 200 in the embodiment does not identify the VIN electrical connector, the GND electrical connector and the signal electrical connector, and the electrical connectors can adopt any structure and arrangement mode disclosed in the embodiment as described above. The inductance assembly 200 shown in FIG. 6B comprises a magnetic core 211, a first main winding 221, a second main winding 222, a first air gap 211-1 and a second air gap 211-2a and 211-2b, wherein the structures and arrangement modes of the first main winding 221 and the second main winding 222 are the same as those of the first main winding 221 and the second main winding 222 shown in FIGS. 3C to 3F. The main winding is electrically connected with the corresponding IPM unit through a first pin arranged on the top surface of the magnetic core, and the main winding penetrates through the lower bottom plate of the magnetic core 211 and is electrically connected with a load through a second pin arranged on the bottom surface of the magnetic core; and the current flowing through the first main winding is opposite to the current direction flowing through the second main winding, the generated main magnetic flux direction is opposite, and the main magnetic fluxes counteract against each other, so that the two-phase inductor works in the anti-coupling state. In addition, the anti-coupling inductor is applied to the two-phase VRM module shown in FIG. 1A, when the phases of the two-phase control pulses are shifted by 180 degrees, the anti-coupling inductor can obtain a large steady-state inductance, current ripples can be reduced, and the conversion efficiency of the VRM module is improved. The anti-coupling inductor can obtain small dynamic inductance, and the dynamic performance of the output voltage can be improved. The first air gap 211-1 is arranged between the two main windings and penetrates to the opposite fourth side surface from the second side surface of the magnetic core 211; and the second air gaps 211-2a and 211-2b are respectively arranged on the second side surface and the fourth side surface of the magnetic core 211 and are parallel to the first side surface or the third side surface of the magnetic core, extend from the second side surface of the magnetic core 211 to the position of the second main winding 222, or extend from the fourth side surface of the magnetic core 211 to the position of the first main winding 221. The first air gap and the second air gap are both arranged on the magnetic flux leakage path and can be used for adjusting the leakage inductance. For example, the larger the air gap, the smaller the leakage inductance is, the better the coupling between the main windings is, that is, the better the anti-coupling performance between the main windings is, the better the steady-state efficiency is improved, and the dynamic performance is improved.

The inductor 200 shown in FIG. 6B can be matched with the top assembly 100 in FIG. 3B like the inductor shown in FIG. 3E; the second side surface of the magnetic core 211 corresponds to the second side edge of the top assembly 100, and the fourth side surface of the magnetic core 211 corresponds to the fourth side edge of the top assembly 100, so that the direction of the main winding is parallel to the first side edge or the third side edge of the top assembly 100, that is, the direction is parallel to the straight line penetrating through the two IPM unit bodies; the size of the two-phase VRM module and the position of SW bonding pad of the IPM unit can be matched to optimize the performance of the inductor 200, and the loss of the inductor 200 is reduced. In another embodiment, the direction of the main winding may also be perpendicular to the first side or the third side of the top assembly 100, that is, perpendicular to the straight line passing through the two IPM unit bodies.

### Embodiment 6

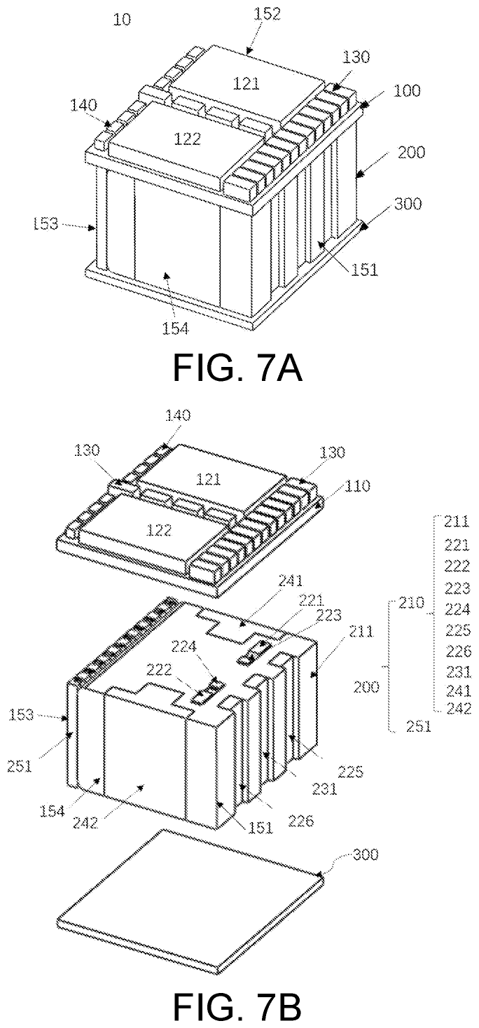

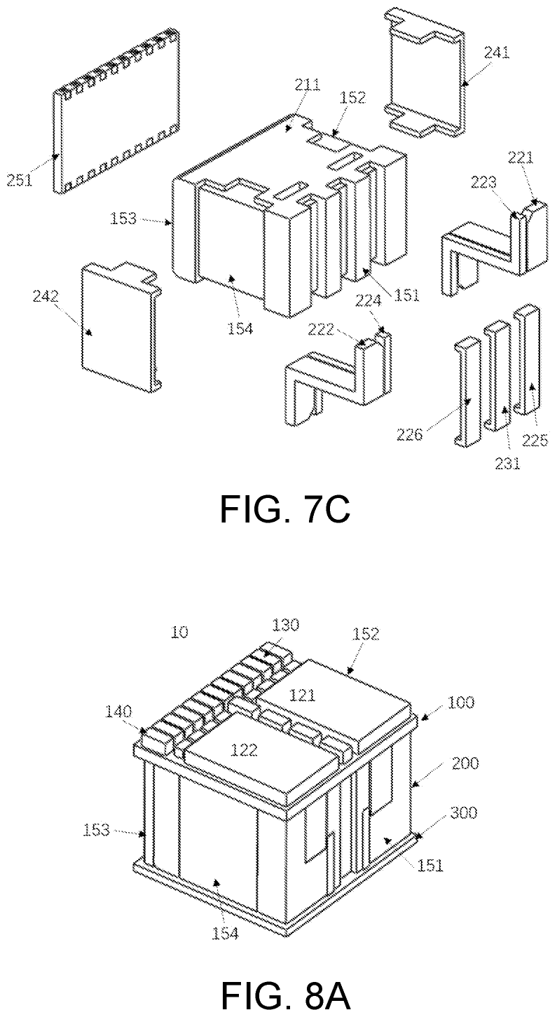

FIG. 7A shows an embodiment of a VRM module with a two-phase TLVR (Trans-Inductor Voltage Regulator) technology. As shown in FIG. 7A, FIG. 7B is an exploded view of the structure of FIG. 7A. The VRM module 10 comprises a top assembly 100, an integrated inductor 200, and a bottom substrate 300.

The top assembly 100 comprises a top substrate 110, a first IPM unit 121, a second IPM unit 122, an input capacitor 130 and other passive elements 140. The first IPM unit 121 and the second IPM unit 122 are disposed in the middle of the upper surface of the top substrate 110, and the bridge arm midpoint SW of each IPM unit is disposed adjacent to the first side 151 of the VRM module. A part of the capacitor of the input capacitor 130 is arranged on the upper surface of the top substrate 110 and is arranged adjacent to the first side surface 151 of the VRM module, and the other part of the input capacitor 130 is arranged between the two IPM units. Other passive elements 140 are disposed on an upper surface of the top substrate 110 and disposed adjacent to a third side surface 153 of the VRM module. The top assembly 100 has the same technical effect as the first embodiment and the fourth embodiment, and details are not described herein again; and the bottom substrate 300 serves as an adapter plate of the output pin of the VRM module so as to meet the requirements of different customers and different application scenes, and a corresponding passive element, such as an output capacitor, can also be arranged. The main problem to be solved by the present embodiment is how to obtain a large sensing amount, a good dynamic performance, and an anti-interference capability of an electrical connector.

FIG. 7C is a schematic exploded view of the integrated inductor 200, the integrated inductor 200 comprises a magnetic core 211, a first main winding 221, a second main winding 222, a first auxiliary winding 223, a second auxiliary winding 224, a VIN electrical connector 231, a GND electrical connector 241/242, a first auxiliary electrical connector 225 and a second auxiliary electrical connector 226. The first main winding 221 and the second main winding 222 are both “Z”-shaped windings, and the first main winding 221 and the first auxiliary winding 223 have the same structural shape and are adjacently arranged; the second main winding 222 and the second auxiliary winding 224 have the same structural shape and are adjacently arranged, and electrical isolation needs to be realized between each winding and the corresponding adjacent auxiliary winding. The two end faces of each winding are exposed out of the upper surface and the lower surface of the VRM module respectively. The same winding shape and adjacent arrangement enable the winding and the auxiliary winding to have good coupling characteristics, so that the VRM module can obtain good dynamic characteristics. The VIN electrical connector 231 is disposed adjacent to the first side surface 151 of the magnetic core 211. The GND electrical connector 241/242 is respectively disposed on the second side surface 152 and the fourth side surface 154 of the magnetic core 211. The first auxiliary electrical connector 225 and the second auxiliary electrical connector 226 are adjacent to the first side surface 151 of the magnetic core 211 and are respectively disposed on two sides of the VIN electrical connector 231; the first auxiliary electrical connector 225 and the first auxiliary winding 223, and the second auxiliary electrical connector 226 and the second auxiliary winding 224 are electrically connected in series through the top substrate 110 and the bottom substrate 300 to form an auxiliary loop of the TLVR, so that the dynamic performance of the VRM module is further improved. In the embodiment, the first main winding and the second main winding are surrounded by the magnetic core in the length range of the winding, so that a good dynamic effect can be obtained while a large inductance is obtained.

### Embodiment 7

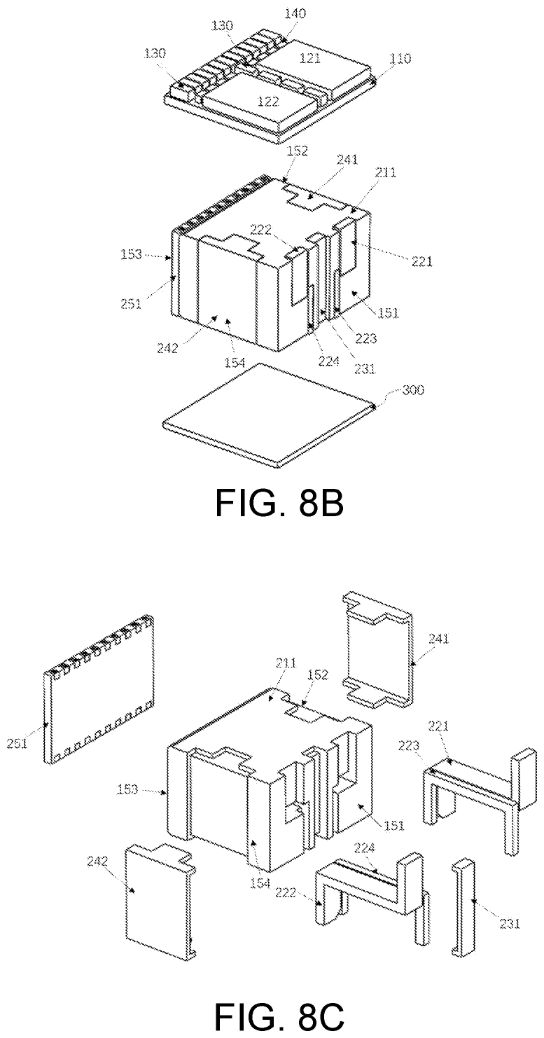

FIG. 8A shows another embodiment of a VRM module with two-phase TLVR technology. As shown in FIG. 8A and FIG. 8B, the VRM module 10 comprises a top assembly 100, and the features of the integrated inductor 200 and the top assembly 100 and the bottom substrate 300 are the same as those of the sixth embodiment.

As shown in the exploded view of the integrated inductor 200 shown in FIG. 8C, different from Embodiment 6, the first auxiliary winding 223 and the second auxiliary winding 224 are both “n”-shaped, and the two end faces of each auxiliary winding are exposed out of the lower surface of the integrated inductor 200. The first main winding 221 and the first auxiliary winding 223 are arranged close to each other, and electrical isolation is arranged between the first main winding 221 and the first auxiliary winding 223. The second main winding 222 is arranged adjacent to the second auxiliary winding 224, and an electrical isolation is arranged between the second main winding 222 and the second auxiliary winding 224. One end of each winding adjacent to the first side surface 151 is exposed to the first side surface 151, and other parts of each winding are surrounded by the magnetic core. The VIN electrical connector 231 is disposed adjacent to the first side surface 151 of the magnetic core 211 and is disposed between the first auxiliary winding 223 and the second auxiliary winding 224. The GND electrical connectors 241/242 are respectively arranged on the second side surface 152 and the fourth side surface 154 of the magnetic core 211. According to the embodiment, the first auxiliary electrical connector and the second auxiliary electrical connector are omitted, the first auxiliary winding 223 and the second auxiliary winding 224 are electrically connected in series through the bottom substrate 300, a circuit of the TLVR auxiliary winding is formed, and the dynamic characteristics of the VRM module are further improved. Compared with the sixth embodiment, the manufacturing method of the integrated inductor 200 disclosed by the embodiment is simpler and more convenient.

### Embodiment 8

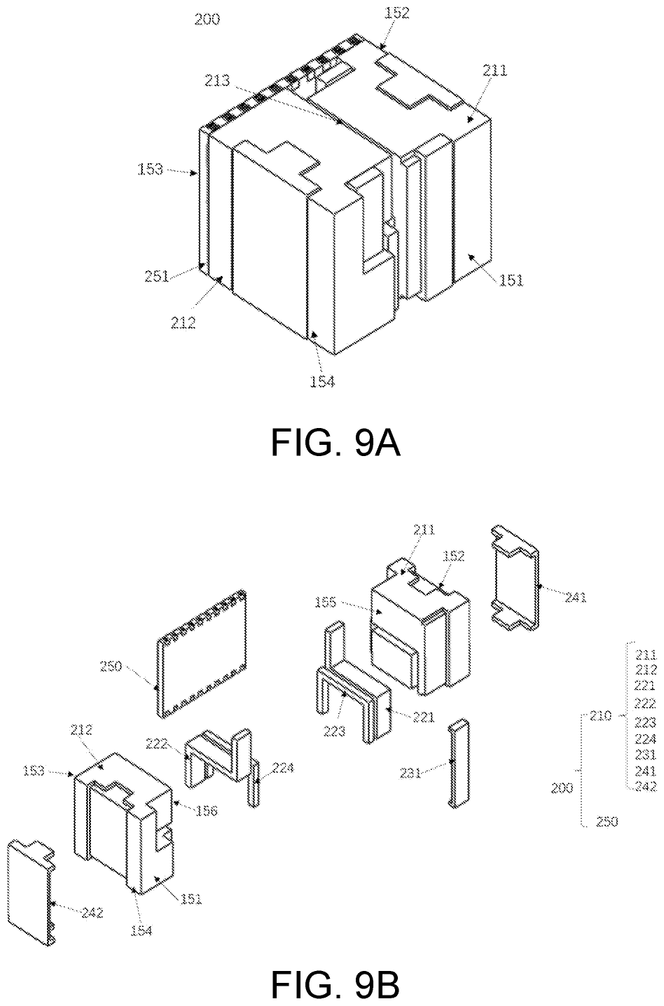

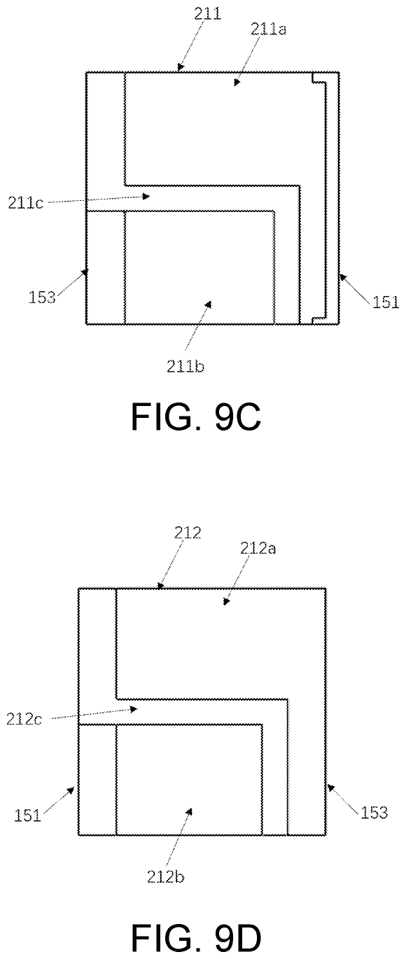

FIG. 9A is another embodiment of an integrated inductor in a VRM module having a two-phase TLVR technology, FIG. 9B is an exploded view of the integrated inductor 200, FIG. 9C is a schematic side view of the inner section 155 in FIG. 9B, and FIG. 9D is a schematic side view of the inner section 156 in FIG. 9B. The integrated inductor 200 comprises a first magnetic core 211, a second magnetic core 212, a first main winding 221, a second main winding 222, a first auxiliary winding 223, a second auxiliary winding 224, a VIN electrical connector 231 and a GND electrical connector 241/242, wherein an air gap 213 is formed between the first magnetic core 211 and the second magnetic core 212 as shown in FIGS. 9C and 9D, the first magnetic core 211 comprises a first magnetic column 211a and a second magnetic column 211b, and a groove 211c is formed between the first magnetic column 211a and the second magnetic column 211b, the groove 211c is used for accommodating the first main winding 221 and the first auxiliary winding 223. The second magnetic core 212 comprises a first magnetic column 212a and a second magnetic column 212b, and a groove 212c is formed between the first magnetic column 212a and the second magnetic column 212b, the groove 212c is used for accommodating the second main winding 222 and the second auxiliary winding 224. The first main winding 221 and the second main winding 222 are both “Z”-shaped, the arrangement direction is opposite, that is, the upper end face of the first main winding 221 on the upper surface of the integrated inductor 200 is adjacent to the third side surface 153, and the lower end face of the lower surface is arranged adjacent to the first side surface 151; the upper end face of the upper surface of the integrated inductor 200 of the second main winding 222 is adjacent to the first side surface 151, and the lower end face of the lower surface is arranged adjacent to the third side surface 153. The first auxiliary winding 223 is arranged adjacent to the first main winding 221 and is electrically isolated from the first main winding 221, and the two end faces of the first auxiliary winding 223 are exposed out of the lower surface of the integrated inductor 200. The second auxiliary winding 224 is arranged adjacent to the second main winding 222 and is electrically isolated from the second main winding 222, and the two end faces of the second auxiliary winding 224 are both exposed out of the lower surface of the integrated inductor 200. The partial shapes of each auxiliary winding and the first main winding 221 or the second main winding 222 are the same, and are adjacent to each other, so that strong coupling between the first main winding 221 or the second main winding 222 and each auxiliary winding can be realized. When current flows from the upper end surface of the first main winding 221 or the second main winding 222 and flows out from the lower end surface, the current flowing through the first main winding 221 and the second main winding 222 is opposite to the inner direction of the magnetic core window (i.e., the horizontal part of the grooves 211c and 212c), and the generated magnetic flux is mutually offset. Therefore, the first main winding 221 and the second main winding 222 work in an anti-coupling state. The reverse coupling can achieve small dynamic inductance, so that rapid dynamic performance is achieved, and meanwhile, high steady-state inductance is achieved, so that the requirement of high efficiency of the VRM module is met. The first auxiliary winding 223 and the second auxiliary winding 224 are both “n”-shaped and are arranged adjacent to the first main winding 221 or the second main winding 222. The parts of the first main winding 221, the second main winding 222, the first auxiliary winding 223 and the second auxiliary winding 224 adjacent to the first side surface 151 and the third side surface 153 of the magnetic core are respectively exposed out of the corresponding side surfaces. The bottom substrate 300, the first auxiliary winding 223 and the second auxiliary winding 224 are connected in series to form an auxiliary winding circuit of a TLVR, so that the TLVR technology is realized, the dynamic inductance is further reduced, and the dynamic performance of the VRM module is improved.

### Embodiment 9

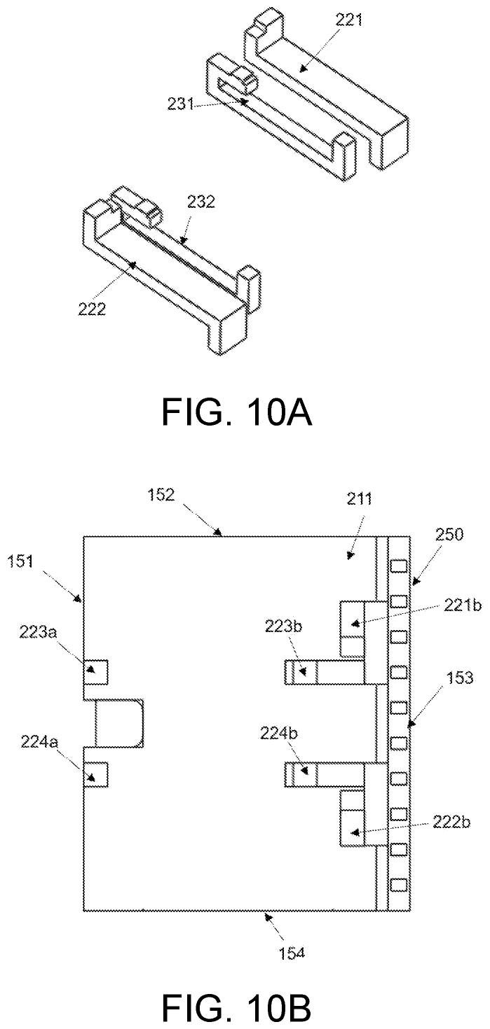

Embodiment 9 discloses a structure of another auxiliary winding. As shown in FIG. 10A, FIG. 10B is a bottom view of the two-phase inductor 200. The two-phase inductor 200 comprises a magnetic core 211, a first main winding 221, a second main winding 222, a first auxiliary winding 223, a second auxiliary winding 224, a VIN electric connector 231 (not shown), a GND electrical connector 241/242 (not shown) and a vertical plate 250, wherein the first main winding 221 and the first auxiliary winding 223 are positively coupled, and the second main winding 222 and the second auxiliary winding 224 are positively coupled. There is no coupling relationship between the first main winding 221 and the second main winding 222, or only weak coupling is present, for example, the coupling coefficient is less than 0.2.

The first main winding 221 and the second main winding 222 are both “Z”-shaped copper sheets, penetrate through the third side surface 153 from the first side surface 151 of the magnetic core 211, extend from the first side surface 151 of the magnetic core 211 to the top surface, and form a first pins 221a and 222a on the top surface of the magnetic core 211; the part, close to the third side surface 153, of the magnetic core 211 extends towards the bottom surface, and a second pin 221b and a second pin 222b are formed on the bottom surface of the magnetic core 211.

The first auxiliary winding 223 and the second auxiliary winding 224 are both “π”-shaped, and both penetrate from the first side surface 151 to the third side surface 153 of the magnetic core 211; one end of the first auxiliary winding 223 and one end of the second auxiliary winding 224 extend from the first side surface 151 to the bottom surface, and first pins 223a and 224a are formed on the bottom surface; the other ends of the first auxiliary winding 223 and the second auxiliary winding 224 extend from the third side surface 153 to the bottom surface and are bent along the middle area of the bottom surface of the bottom surface facing the magnetic core 211, and the second pins 223b and 224b are formed in the middle area of the bottom surface, so that the arrangement has the advantages that the coupling performance is considered between the second pin 221b of the first main winding and the second pin 223b of the first auxiliary winding 223, and electrical isolation is easy to realize; the second pin 222b of the second main winding and the second pin 224b of the second auxiliary winding 224, electrical isolation is easy to achieve, the coupling coefficient between the main winding and the auxiliary winding is improved, the insulation strength is enhanced, and the reliability is improved while the dynamic performance is improved.

The structures of the first auxiliary winding 223 and the second auxiliary winding 224 shown in the embodiment can be applied to the embodiment, the same technical benefits can also be obtained, and the other technical features are the same as the technical features of the previous embodiment.

The power conversion device can be part of the electronic device or an independent power supply module as long as the technical features and advantages disclosed by the application can be met. The copper sheet or the copper column disclosed by the application is not only limited to one metal of copper, but also can be other conductive metals.

The “equal” or “same” or “equal to” disclosed by the application needs to consider the parameter distribution of engineering, and the error distribution is within +/−30%; the two line segments or the two straight lines are defined as the two line segments or the included angle between the two line segments or the two straight lines is less than or equal to 45 degrees; the included angle between the two line segments or the two straight lines is within the range of [60, 120]; and the definition of the phase error phase also needs to consider the parameter distribution of the project, and the error distribution of the phase error degree is within +/−30%.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An inductance assembly comprises a magnetic core, a first main winding, a second main winding, a first auxiliary winding and a second auxiliary winding;
wherein the magnetic core comprises a top surface and a bottom surface opposite to each other, a first side surface and a third side surface opposite to each other, and a second side surface and a fourth side surface opposite to each other; and
wherein a first pin of the first main winding and a first pin of the second main winding are arranged on the top surface of the magnetic core; a second pin of the first main winding and a second pin of the second main winding, and at least one pin of the first auxiliary winding and at least one pin of the second auxiliary winding are arranged on the bottom surface of the magnetic core; the first main winding and the second main winding respectively pass through the magnetic core; the first auxiliary winding is coupled with the first main winding, and the second auxiliary winding is coupled with the second main winding; and any auxiliary winding is electrically isolated from an adjacent main winding.

2. The inductance assembly of claim 1, wherein the first main winding, the first auxiliary winding, the second auxiliary winding and the second main winding are sequentially arranged; the first auxiliary winding is arranged adjacent to the first main winding, and the second auxiliary winding is arranged adjacent to the second main winding; the first main winding and the second main winding respectively comprise a main body, a first end part and a second end part, and the first auxiliary winding and the second auxiliary winding comprise a main body, a first end part and a second end part respectively; the main body of the first auxiliary winding and the main body of the first main winding extend from the respective first end parts to the second end parts in the same direction, and the main body of the second auxiliary winding and the main body of the second main winding extend from the respective first end parts to the second end parts in the same direction.

3. The inductance assembly of claim 2, wherein an upper end of the first auxiliary winding and an upper end of the second auxiliary winding are exposed out of the top surface of the magnetic core, and a lower end of the first auxiliary winding and a lower end of the second auxiliary winding are exposed out of the bottom surface of the magnetic core; the first main winding, the second main winding, the first auxiliary winding and the second auxiliary winding are all arranged close to the first side surface, and the second end parts of the first main winding, the second main winding, the first auxiliary winding and the second auxiliary winding are all arranged close to the third side surface.

4. The inductance assembly of claim 2, wherein an upper end and a lower end of the first auxiliary winding and an upper end and a lower end of the second auxiliary winding are exposed out of the bottom surface of the magnetic core; the first main winding, the second main winding, the first auxiliary winding and the second auxiliary winding are all arranged close to the first side surface, and the second end parts of the first main winding, the second main winding, the first auxiliary winding and the second auxiliary winding are all arranged close to the third side surface.

5. The inductance assembly of claim 1, wherein the first auxiliary winding, the first main winding, the second main winding and the second auxiliary winding are sequentially arranged; the first auxiliary winding is arranged adjacent to the first main winding, and the second auxiliary winding is arranged adjacent to the second main winding; the first main winding and the second main winding both comprise a main body, a first end part and a second end part, and the first auxiliary winding and the second auxiliary winding both comprise a main body, a first end part and a second end part; the main body of the first auxiliary winding and the main body of the first main winding extend from the respective first end parts to the second end parts in the same direction, and the main body of the second auxiliary winding and the main body of the second main winding extend from the respective first end parts to the second end parts in the same direction; the first end part of the first auxiliary winding, the first end part of the first main winding, the second end part of the second main winding and the second end part of the second auxiliary winding are arranged adjacent to the first side surface, and the second end part of the first auxiliary winding, the second end part of the first main winding, the first end part of the second main winding and the first part end of the second auxiliary winding are all arranged close to the third side surface.

6. The inductance assembly of claim 1, wherein the first main winding and the second main winding both comprise a main body, a first end part and a second end part, and the first auxiliary winding and the second auxiliary winding both comprise a main body, a first end part and a second end part; the main bodies of the first main winding and the second main winding are C-shaped, and the main bodies of the first auxiliary winding and the second auxiliary winding extend from the respective first end parts to the second end parts in the same direction; a first end part and a second end part of the first main winding, the first end part of the first auxiliary winding and the first end part of the second auxiliary winding are arranged adjacent to the first side surface, the first end part and the second end part of the second main winding are arranged close to the third side surface, and the second end part of the first auxiliary winding and the second end part of the second auxiliary winding are arranged close to the third side surface; the first auxiliary winding is arranged adjacent to the second side surface and is adjacent to the main body of the first main winding and the main body of the second main winding, and the second auxiliary winding is arranged adjacent to the fourth side surface and is adjacent to the main body of the first main winding and the main body of the other part of the second main winding; the first auxiliary winding is coupled to the first main winding, the first auxiliary winding is coupled to the second main winding, the second auxiliary winding is coupled to the first main winding, and the second auxiliary winding is coupled to the second main winding.

7. The inductance assembly of claim 3, wherein the inductance assembly is formed by pressing and forming a magnetic core material, a first main winding, a second main winding, a first auxiliary winding and a second auxiliary winding.

8. The inductance assembly of claim 3, wherein the magnetic core is formed by assembling.

9. The inductance assembly of claim 1, wherein the inductance assembly further comprises at least one VIN electrical connector and two GND electrical connectors; and the at least one VIN electrical connector is arranged adjacent to the first side surface and/or the third side surface, and the two GND electrical connectors are arranged on the second side surface and the fourth side surface respectively; upper ends of the VIN electrical connector and the GND electrical connector are exposed out of the top surface of the magnetic core, and lower ends of the VIN electrical connector and the GND electrical connector are exposed out of the bottom surface of the magnetic core.

10. The inductance assembly of claim 9, wherein at least one of the at least one VIN electrical connections is disposed adjacent to the first side surface and is disposed between the first main winding and the second main winding.

11. The inductance assembly of claim 9, wherein the at least one VIN electrical connector is disposed adjacent to the third side surface, the VIN electrical connector includes a first pin, a second pin, and a middle portion, the first pin of the VIN electrical connector is disposed on a top surface of the magnetic core, the second pin of the VIN electrical connector is disposed on a bottom surface of the magnetic core, and a width of the middle portion is greater than a width of the first pin and the second pin of the VIN electrical connector.

12. The inductance assembly of claim 11, wherein the inductance assembly further comprises a signal electrical connector, and at least one part of the signal electrical connector is arranged on outer side of the middle portion of the VIN electrical connector; and the middle portion is used for shielding electromagnetic interference of the first main winding and the second main winding on at least one part of the signal electrical connector.

13. The inductance assembly of claim 9, wherein the inductance assembly further comprises a signal electrical connector, and at least a part of the signal electrical connector is disposed adjacent to the third side surface.

14. The inductance assembly of claim 13, wherein the signal electrical connector is a pin header.

15. The inductance assembly of claim 13, wherein the VIN electrical connector, the GND electrical connector, or the signal electrical connector are formed by a metallization process.

16. The inductance assembly of claim 9, wherein the VIN electrical connector or the GND electrical connector is a metal column.

17. The inductance assembly of claim 12, wherein a second pin of the first main winding and a second pin of the second main winding protrude out of the bottom surface of the magnetic core;
the first pin and the second pin of the VIN electrical connector are respectively connected to the middle portion by means of a step structure, and the step structure is used for avoiding the signal electrical connector.

18. The inductance assembly of claim 5, wherein the magnetic core is provided with an air gap; and at least a part of the air gap is located between the first main winding and the second main winding.

19. The inductance assembly of claim 18, wherein the magnetic core is formed by assembling, and the air gap divides the magnetic core into two halves in a vertical direction; the magnetic core is further provided with a groove, and the groove is used for accommodating the first main winding and the second main winding, and the groove is communicated with the air gap.

20. The inductance assembly of claim 19, wherein the air gap comprises a first air gap, the first air gap is a horizontal flat through hole shape, the first air gap penetrates from one of the first to fourth side surfaces of the magnetic core to an opposite one of the first to fourth side surface, and the first air gap extends from a main winding main body of the first main winding to a main winding main body of the second main winding.

21. The inductance assembly of claim 9, wherein a second end of the first auxiliary winding and a second end of the second auxiliary winding are bent along a middle area of the bottom surface of the magnetic core, and a second pin is formed in a middle area of the bottom surface.

22. An inductance assembly comprises a magnetic core, a first main winding, a second main winding, a VIN electrical connector and a GND electrical connector;
the magnetic core comprises a top surface and a bottom surface opposite to each other, a first side surface and a third side surface opposite to each other, and a second side surface and a fourth side surface opposite to each other;
a first pin of the first main winding and a first pin of the second main winding are arranged on the top surface of the magnetic core; a second pin of the first main winding and a second pin of the second main winding are arranged on the bottom surface of the magnetic core; the first main winding and the second main winding respectively penetrate through the magnetic core;
the VIN electrical connector is arranged adjacent to the third side surface, and the GND electrical connector is arranged on the second side surface and the fourth side surface respectively; upper ends of the VIN electrical connector and the GND electrical connector are exposed out of the top surface of the magnetic core, and lower ends of the VIN electrical connector and the GND electrical connector are exposed out of the bottom surface of the magnetic core; the VIN electrical connector comprises a first pin, a second pin and a middle portion, the first pin of the VIN electrical connector is arranged on the top surface of the magnetic core, the second pin of the VIN electrical connector is arranged on the bottom surface of the magnetic core, and a width of the middle portion is larger than that of the first pin and the second pin of the VIN electrical connector.

23. The inductance assembly of claim 22, further comprising a plastic package body and a signal electrical connector, wherein the plastic package body covers the magnetic core, the VIN electrical connector and the GND electrical connector, and at least a part of the signal electrical connector is arranged on an outer side of the middle portion of the VIN electrical connector; and the middle portion is used for shielding electromagnetic interference of the first main winding and the second main winding on at least a part of the signal electrical connector.

24. The inductance assembly of claim 22, wherein the first main winding and the second main winding are I-shaped.

25. The inductance assembly according to claim 22, wherein the first main winding and the second main winding respectively comprise a first end part, a main body and a second end part, and the main bodies of the first main winding and the second main winding extend from the respective first end parts to second end parts in opposite directions; the first end part of the first main winding and the second end part of the second main winding are arranged adjacent to the first side surface, and the second end part of the first main winding and the first end part of the first main winding are arranged close to the third side surface.

26. The inductance assembly of claim 22, wherein the VIN electrical connector and the GND electrical connector are formed by a metallization process.

27. The inductance assembly of claim 22, wherein the VIN electrical connector and the GND electrical connector are metal columns.

28. The inductance assembly of claim 25, wherein the magnetic core is provided with an air gap; and at least a part of the air gap is located between the first main winding and the second main winding.

29. The inductance assembly of claim 28, wherein the air gap divides the magnetic core into two halves in a vertical direction, the magnetic core is further provided with a groove, the groove is used for accommodating the first main winding and the second main winding, and the groove is in communication with the air gap.

30. An integrated power converter module comprises the inductance assembly of claim 13 or 23; the integrated power converter module further comprises a top assembly and a bottom substrate, the top assembly is arranged on the top surface of the inductance assembly, and the bottom substrate is arranged on the bottom surface of the inductance assembly; the first pin of the first main winding, the first pin of the second main winding, the upper end of the VIN electrical connector and the upper end of the GND electrical connector are electrically connected with the top assembly, the second pin of the first main winding, the second pin of the second main winding, the lower end of the VIN electrical connector and the lower end of the GND electrical connector are electrically connected with the bottom substrate.

31. The integrated power converter module of claim 30, wherein the signal electrical connector extends from the top surface of the inductance assembly to the bottom surface of the bottom substrate through a side surface of a plastic packaging material.

32. The integrated power converter module of claim 30, wherein an upper end of the signal electrical connector is arranged on the top surface of the inductance assembly and is electrically connected with the top assembly; and a lower end of the signal electrical connector is arranged on the bottom surface of the inductance assembly and is electrically connected with the bottom substrate.

33. The integrated power converter module of claim 30, further comprising an output capacitor, wherein the output capacitor is arranged between the magnetic core and the bottom substrate; one end of the output capacitor, the second pin of the first main winding and the second pin of the second main winding are electrically connected.

34. The integrated power converter module of claim 32, wherein the upper end and the lower end of the VIN electrical connector are respectively connected to a middle portion of the VIN electrical connector by means of a step structure, and the step structure is used for avoiding the signal electrical connector.

35. The integrated power converter module of claim 32, wherein the top assembly comprises a top substrate, an input capacitor and two IPM units; the IPM units are electrically connected with the upper end of the VIN electrical connector, the IPM units are electrically connected with the upper end of the GND electrical connector, the first pin of the first main winding is electrically connected with one of the two IPM units, and the first pin of the second main winding is electrically connected with the other one of the two IPM units.

36. An integrated power converter module comprises an inductance assembly, a bottom substrate, a plastic packaging material and a signal electrical connector;
the inductance assembly is arranged on a top surface of the bottom substrate; the plastic packaging material wraps part of top surfaces of the inductance assembly and the bottom substrate;
the inductance assembly comprises a magnetic core, a first main winding, a second main winding, a VIN electrical connector and a GND electrical connector;
an upper end of the first main winding, an upper end of the second main winding, an upper end of the VIN electrical connector and an upper end of the GND electrical connector are exposed out of the plastic packaging material from the top surface of the inductance assembly respectively, and a lower end of the first main winding, a lower end of the second main winding, a lower end of the VIN electrical connector and a lower end of the GND electrical connector are electrically connected with the bottom substrate respectively; the first main winding and the second main winding respectively penetrate through the magnetic core; the signal electrical connector extends from the top surface of the inductance assembly to a bottom surface of the bottom substrate through a side surface of the plastic packaging material; and the signal electrical connector is formed through a metallization process.

37. The integrated power converter module of claim 36, wherein the side surface of the plastic packaging material is formed through plate splitting and cutting, and the signal electrical connector is an electroplated half-hole.

38. The integrated power converter module of claim 36, further comprising a top assembly, and the top assembly is arranged adjacent to a top surface of the magnetic core; the top assembly comprises a top substrate, an input capacitor and two IPM units; the input capacitor and the two IPM units are arranged on a top surface of the top substrate; the IPM units are electrically connected with the upper end of the VIN electrical connector; the IPM units are electrically connected with the upper end of the GND electrical connector; the upper end of the first main winding is electrically connected with one of the two IPM units, and the upper end of the second main winding is electrically connected with the other one of the two IPM units.

39. The integrated power converter module of claim 36, further comprising an output capacitor, wherein the output capacitor is arranged between the magnetic core and the bottom substrate; one end of the output capacitor and the lower end of the first main winding are electrically connected with the lower end of the second main winding.

40. The integrated power converter module of claim 39 further comprises a metal frame, wherein the metal frame is electrically connected the inductance assembly with the bottom substrate; the metal frame is arranged between the magnetic core and the bottom substrate; and the metal frame is arranged around the output capacitor, and the metal frame is provided with a gap or a groove allowing plastic packaging materials to flow in.

41. The integrated power converter module of claim 36, wherein the magnetic core is provided with a first side surface and a third side surface which are opposite, and the magnetic core is further provided with a second side surface and a fourth side surface opposite to each other; and the VIN electrical connector is arranged on the first side surface and/or the third side surface, and the GND electrical connector is arranged on the second side surface and/or the fourth side surface.

42. The integrated power converter module of claim 36, wherein the inductance assembly further comprises a first auxiliary winding and a second auxiliary winding; the first auxiliary winding is positively coupled with the first main winding, and the second auxiliary winding is positively coupled with the second main winding; and the first auxiliary winding and the second auxiliary winding are used for forming a closed loop of a TLVR inductance technology.

43. The integrated power converter module of claim 36, wherein the first main winding and the second main winding respectively comprise a main body, a first end part of a main winding and a second end part of the main winding; the first end part of the main winding extends from one end of a main winding main body to a top surface of the magnetic core, and the second end part of the main winding extends from an other end of the main winding main body to the bottom substrate of the magnetic core; and the main winding main body is horizontally arranged.

44. The integrated power converter module of claim 43, wherein the inductance assembly further comprises a first auxiliary winding and a second auxiliary winding; and the first auxiliary winding and the second auxiliary winding respectively comprise an auxiliary winding main body, a first end part of an auxiliary winding and a second end part of the auxiliary winding; the first end part of the main winding extends from one end of the main winding main body to the bottom substrate, and the second end part of the main winding extends from the other end of the main winding main body to the bottom substrate of the magnetic core; the auxiliary winding main body is positively coupled with the first main winding, and/or the auxiliary winding main body and the second main winding are positively coupled; and the first auxiliary winding and the second auxiliary winding are used for forming a closed loop of a TLVR inductance technology.

45. The integrated power converter module of claim 43, a low magnetic permeability material is provided between a main body of an auxiliary winding and a main body of the main winding.

46. The integrated power converter module of claim 44, wherein the main winding main body comprises a main winding first main body, a main winding second main body and a main winding third main body which are connected in sequence; the main winding first main body, the main winding second main body and the main winding third main body are arranged in a C-shaped horizontal bypass mode; the first main winding and the second main winding are arranged in a second-order rotation symmetry mode; the main winding second main body of the first main winding and the main winding second main body of the second main winding are reversely coupled; and the first main winding and the second main winding are both coupled with the first auxiliary winding, and the first main winding and the second main winding are both coupled with the second auxiliary winding.

47. The integrated power converter module of claim 43, wherein a spacing between the signal electrical connector and the second end part of the nearest main winding is less than a spacing between the signal electrical connector and the first end part of any main winding.

48. The integrated power converter module of claim 43, wherein the inductance assembly has a second-order rotationally symmetrical structure, and the signal electrical connector is arranged on the inductance assembly in a second-order rotationally symmetric manner.

49. An integrated power converter module comprises an inductance assembly, a bottom substrate, a plastic packaging material and a signal electrical connector, wherein the signal electrical connector is arranged on a side surface of the inductance assembly;
the inductance assembly comprises a magnetic core, a first main winding, a second main winding, a VIN electrical connector and a GND electrical connector;
an upper end of the first main winding, an upper end of the second main winding, an upper end of the VIN electrical connector and an upper end of the GND electrical connector are exposed out of the plastic packaging material from a top surface of the inductance assembly respectively, and a lower end of the first main winding, a lower end of the second main winding, a lower end of the VIN electrical connector and a lower end of the GND electrical connector are electrically connected with the bottom substrate respectively; and the first main winding and the second main winding respectively penetrate through the magnetic core;
the first main winding and the second main winding respectively comprise a main winding main body, a main winding first end and a main winding second end; the main winding first end extends from one end of the main winding main body to a top surface of the magnetic core, and the main winding second end extends from an other end of the main winding main body to the bottom substrate of the magnetic core; the main winding main body is horizontally arranged;
the first main winding and the second main winding are arranged in a second-order rotationally symmetrical manner, and the first main winding and the second main winding are reversely coupled.

50. The integrated power converter module of claim 49, a low-permeability material is arranged between the main winding main body of the first main winding and the main winding main body of the second main winding.

51. The integrated power converter module of claim 49, wherein the magnetic core is provided with an air gap; and at least a part of the air gap is located between the first main winding and the second main winding.

52. The integrated power converter module of claim 51, wherein the air gap divides the magnetic core into two halves in a vertical direction.

53. The integrated power converter module of claim 52, wherein the magnetic core is further provided with a groove, the groove is used for accommodating the first main winding and the second main winding, and the groove is communicated with the air gap.

54. The integrated power converter module of claim 51, wherein the air gap comprises a first air gap, the first air gap is a horizontal flat through hole shape, the first air gap penetrates from one side surface of the magnetic core to an other opposite side surface of the magnetic core, and the first air gap extends from the main winding main body of the first main winding to the main winding main body of the second main winding.

55. The integrated power converter module of claim 54, wherein the air gap further comprises a second air gap, the second air gap is communicated with the first air gap, the second air gap is in a vertical groove shape, and the second air gap penetrates through the top surface of the magnetic core to a bottom surface of the magnetic core; and the second air gap extends from the first main winding or the second main winding to one side surface of the magnetic core.

56. The integrated power converter module of claim 49, wherein the inductance assembly further includes a first auxiliary winding and a second auxiliary winding; and the first auxiliary winding and the second auxiliary winding respectively comprise an auxiliary winding main body, a first end part of an auxiliary winding and a second end part of the auxiliary winding; the main winding first end extends from one end of the main winding main body to the bottom substrate, and the main winding second end extends from the other end of the main winding main body to the bottom substrate of the magnetic core; the auxiliary winding is coupled with the first main winding, and/or the auxiliary winding is coupled with the second main winding; and the first auxiliary winding and the second auxiliary winding are used for forming a closed loop of a TLVR inductance technology.

57. The integrated power converter module of claim 56, a low-permeability material is arranged between the auxiliary winding main body and the main winding main body.

58. The integrated power converter module of claim 49, wherein the integrated power converter module further comprises a top assembly, and the top assembly is arranged close to the top surface of the magnetic core; the top assembly comprises a top substrate, an input capacitor and two IPM units; the input capacitor and the two IPM units are arranged on a top surface of the top substrate; the IPM units are electrically connected with the upper end of the VIN electrical connector; the IPM units are electrically connected with the upper end of the GND electrical connector; the upper end of the first main winding is electrically connected with one of the two IPM units, and the upper end of the second main winding is electrically connected with an other one of the two IPM units; and the two IPM units are arranged in a second-order rotating symmetry mode.

59. The integrated power converter module of claim 49, wherein the magnetic core is provided with a first side surface and a third side surface opposite to each other, and the magnetic core further has a second side surface and a fourth side surface opposite to each other; the VIN electrical connector is arranged on the first side surface and/or the third side surface, and the GND electrical connector is arranged on the second side surface and/or the fourth side surface.
